(19) United States
(12) Patent Application Publication
(10) Pub. No.: US 2013/0189665 A1
(43) Pub. Date: Jul. 25, 2013

(54) METHODS, COMPUTER-READABLE STORAGE MEDIA, AND APPARATUSES FOR DISTIRBUTION OF EDUCATIONAL COURSE CONTENT

(71) Applicant: Darrell A. Ross, Edmonton (CA)

(72) Inventor: Darrell A. Ross, Edmonton (CA)

(21) Appl. No.: 13/743,993

(22) Filed: Jan. 17, 2013

Related U.S. Application Data
(60) Provisional application No. 61/589,815, filed on Jan. 23, 2012.

(51) Int. Cl. G09B 7/00

(52) U.S. Cl. CPC G09B 7/00
USPC 434/308; 434/335; 434/362

(57) ABSTRACT

A method of distributing educational course content to a user of a first computer according to an illustrative embodiment involves causing the first computer to present educational information retrieved from a first at least one computer-readable storage medium comprising the educational information stored thereon in association with one of a first plurality of educational modules, the educational information presented by the first computer and stored on the first at least one computer-readable storage medium in association with the one of the first plurality of educational modules comprising at least one question, instructional information, and at least one explanation for a respective correct answer to a respective one of the at least one question. Causing the first computer to present the instructional information involves causing the first computer to present at least a portion of the instructional information while the at least one question is being presented by the first computer.

### CROSS-REFERENCE TO RELATED APPLICATION

This application claims the benefit of and priority to U.S. provisional patent application No. 61/589,815 filed Jan. 23, 2012, the entire contents of which are incorporated by reference herein.

### BACKGROUND

1. Field

The invention relates generally to distribution of educational course content, and more particularly to methods, computer-readable storage media, and apparatuses for distribution of educational course content.

2. Description of Related Art

Many traditional didactic learning methods involve a teacher presenting educational course content to students, followed by testing of the students' knowledge of the educational course content. However, such traditional didactic learning methods are sometimes not as effective as problem-based learning methods, which may more actively engage the students and which may thus facilitate greater retention of educational course content.

Recently, various online learning methods have emerged. Many such online learning methods simply involve a teacher making educational course content available to students over a computer network such as the internet. However, many online learning methods do not allow a teacher to transfer or revise discrete units of educational course content conveniently. Therefore, such online learning methods do not allow convenient revision or exchange of any such discrete units of educational course content, and such online learning methods do not allow convenient collaboration between teachers. Further, many online learning methods simply automate traditional didactic learning methods, and therefore generally involve the same disadvantages as traditional didactic learning methods.

### SUMMARY

In accordance with one illustrative embodiment, there is provided a method of distributing educational course content to a user of a first computer. The method comprises causing the first computer to present educational information retrieved from a first at least one computer-readable storage medium comprising the educational information stored thereon in association with one of a first plurality of educational modules, the educational information presented by the first computer and stored on the first at least one computer-readable storage medium in association with the one of the first plurality of educational modules comprising at least one question, instructional information, and at least one explanation for a respective correct answer to a respective one of the at least one question. Causing the first computer to present the educational information comprises causing the first computer to present at least a portion of the instructional information while the at least one question is being presented by the first computer.

Causing the first computer to present the educational information may comprise causing the first computer to display text of the at least one question.

Causing the first computer to display the text of the at least one question may comprise causing the first computer to display the text of the at least one question on a display screen of the first computer.

The instructional information may comprise at least one visual image.

Causing the first computer to present the educational information may comprise causing the first computer to display the at least one visual image on the display screen of the first computer.

Causing the first computer to display the at least one visual image on the display screen of the first computer may comprise causing the first computer to display the at least one visual image on the display screen of the first computer contemporaneously with the text of the at least one question.

Causing the first computer to display the at least one question and the at least one visual image on the display screen of the first computer may comprise causing the first computer to present the at least one question on a left side of the display screen of the first computer and causing the first computer to present the at least one visual image on a right side of the display screen of the first computer.

Causing the first computer to display the at least one question and the at least one visual image on the display screen of the first computer may comprise causing the first computer to present the at least one question on a right side of the display screen of the first computer and causing the first computer to present the at least one visual image on a left side of the display screen of the first computer.

The instructional information may comprise at least one audio recording of at least one lecture segment.

Causing the first computer to present the educational information may comprise causing the first computer to present the at least one audio recording in response to a request from the user of the first computer for presentation of the at least one audio recording.

The educational information presented by the first computer and stored on the first at least one computer-readable storage medium in association with the one of the first plurality of educational modules may further comprise a plurality of possible answers to each one of the at least one question.

Causing the first computer to present the educational information may comprise causing the first computer to display text of the possible answers.

Causing the first computer to present the educational information may comprise causing the first computer to present the at least one question and the possible answers contemporaneously.

Causing the first computer to present the educational information may comprise causing the first computer to present the instructional information independently of any selection of any of the possible answers by the user of the first computer.

Causing the first computer to present the educational information may comprise causing the first computer to present the at least one explanation in response to a request from the user of the first computer for the at least one explanation.

Causing the first computer to present the educational information may comprise causing the first computer to display text of the at least one explanation.

Causing the first computer to present the educational information may comprise transmitting, to the first computer, a first at least one signal encoded with codes to cause the first computer to present the educational information.

The codes of the first at least one signal may comprise hypertext markup language codes.

The method may further comprise causing the first at least one computer-readable storage medium to store the educational information in association with the one of the first plurality of educational modules.

Causing the first at least one computer-readable storage medium to store the educational information in association with the one of the first plurality of educational modules may comprise receiving the educational information.

Receiving the educational information may comprise receiving a second at least one signal encoded with codes representing the educational information associated with the one of the first plurality of educational modules.

The method may further comprise causing the first at least one computer-readable storage medium to associate the one of the first plurality of educational modules with a first one of a plurality of lectures.

The method may further comprise causing the first at least one computer-readable storage medium to associate the first one of the plurality of lectures with a first one of a plurality of courses.

The method may further comprise causing the first at least one computer-readable storage medium to associate the one of the first plurality of educational modules with a second one of the plurality of lectures different from the first one of the plurality of lectures.

The method may further comprise causing the first at least one computer-readable storage medium to associate a plurality of educational modules of the first plurality of educational modules with the first one of the plurality of lectures such that the first at least one computer-readable storage medium may comprise stored thereon, in association with each one of the first plurality of educational modules associated with the first one of the plurality of lectures, a respective at least one question, respective instructional information, and a respective at least one explanation for a respective correct answer to a respective one of the respective at least one question.

The method may further comprise causing a second at least one computer-readable storage medium different from the first at least one computer-readable storage medium to store the educational information in association with one of a second plurality of educational modules different from the first plurality of educational modules.

Causing the second at least one computer-readable storage medium to store may comprise transmitting a third at least one signal to a second computer comprising the second at least one computer-readable storage medium.

The method may further comprise: receiving, from the first computer, a fourth at least one signal encoded with codes representing feedback associated with the one of the first plurality of educational modules; and causing the first at least one computer-readable storage medium to store the feedback in association with the one of the first plurality of educational modules.

In accordance with another illustrative embodiment, there is provided at least one computer-readable storage medium comprising stored thereon program codes for directing at least one processor circuit to implement the method.

In accordance with another illustrative embodiment, there is provided an apparatus for distributing educational course content. The apparatus comprises: at least one processor circuit; and at least one computer-readable storage medium comprising stored thereon program codes for directing the at least one processor circuit to implement the method.

In accordance with another illustrative embodiment, there is provided an apparatus for distributing educational course content to a user of a first computer. The apparatus comprises: a means for retrieving educational information from a first at least one computer-readable storage medium comprising the educational information stored thereon in association with one of a first plurality of educational modules, wherein the educational information that the means for retrieving is configured to retrieve from the first at least one computer-readable storage medium comprises at least one question, instructional information, and at least one explanation for a respective correct answer to a respective one of the at least one question; and a means for causing the first computer to present the educational information retrieved from the first at least one computer-readable storage medium, wherein the means for causing is configured to cause the first computer to present at least a portion of the instructional information while the at least one question is being presented by the first computer.

The means for causing the first computer to present may be configured to cause the first computer to display text of the at least one question.

The means for causing the first computer to present may be configured to cause the first computer to display the text of the at least one question on a display screen of the first computer.

The instructional information that the means for retrieving is configured to retrieve from the first at least one computer-readable storage medium, and that the means for causing the first computer to present is configured to cause the first computer to present, may comprise at least one visual image.

The means for causing the first computer to present may be configured to cause the first computer to display the at least one visual image on the display screen of the first computer.

The means for causing the first computer to present may be configured to cause the first computer to display the at least one visual image on the display screen of the first computer contemporaneously with the text of the at least one question.

The means for causing the first computer to present may be configured to cause the first computer to present the at least one question on a left side of the display screen of the first computer and to present the at least one visual image on a right side of the display screen of the first computer.

The means for causing the first computer to present may be configured to cause the first computer to present the at least one question on a right side of the display screen of the first computer and to present the at least one visual image on a left side of the display screen of the first computer.

The instructional information that the means for retrieving is configured to retrieve from the first at least one computer-readable storage medium, and that the means for causing the first computer to present is configured to cause the first computer to present, may comprise at least one audio recording of at least one lecture segment.

The means for causing the first computer to present may be configured to cause the first computer to present the at least one audio recording in response to a request from the user of the first computer for presentation of the at least one audio recording.

The educational information that the means for retrieving is configured to retrieve from the first at least one computer-readable storage medium, and that the means for causing the first computer to present is configured to cause the first computer to present, may further comprise a plurality of possible answers to each one of the at least one question.

The means for causing the first computer to present may be configured to cause causing the first computer to display text of the possible answers.

The means for causing the first computer to present may be configured to cause the first computer to present the at least one question and the possible answers contemporaneously.

The means for causing the first computer to present may be configured to cause the first computer to present the instructional information independently of any selection of any of the possible answers by the user of the first computer.

The means for causing the first computer to present may be configured to cause the first computer to present the at least one explanation in response to a request from the user of the first computer for the at least one explanation.

The means for causing the first computer to present may be configured to cause the first computer to display text of the at least one explanation.

The means for causing the first computer to present may comprise a means for transmitting, to the first computer, a first at least one signal encoded with codes to cause the first computer to present the educational information.

The codes of the first at least one signal may comprise hypertext markup language codes.

The apparatus may further comprise a means for causing the first at least one computer-readable storage medium to store the educational information in association with the one of the first plurality of educational modules.

The means for causing the first at least one computer-readable storage medium to store the educational information in association with the one of the first plurality of educational modules may comprise a means for receiving the educational information.

The means for receiving the educational information may be configured to receive a second at least one signal encoded with codes representing the educational information associated with the one of the first plurality of educational modules.

The apparatus may further comprise a means for causing the first at least one computer-readable storage medium to associate the one of the first plurality of educational modules with a first one of a plurality of lectures.

The apparatus may further comprise a means for causing the first at least one computer-readable storage medium to associate the first one of the plurality of lectures with a first one of a plurality of courses.

The apparatus may further comprise a means for causing the first at least one computer-readable storage medium to associate the one of the first plurality of educational modules with a second one of the plurality of lectures different from the first one of the plurality of lectures.

The apparatus may further comprise a means for causing the first at least one computer-readable storage medium to associate a plurality of educational modules of the first plurality of educational modules with the first one of the plurality of lectures. The means for causing the first at least one computer-readable storage medium to associate may be configured to cause the first at least one computer-readable storage medium to store thereon, in association with each one of the first plurality of educational modules associated with the first one of the plurality of lectures, a respective at least one question, respective instructional information, and a respective at least one explanation for a respective correct answer to a respective one of the respective at least one question.

The apparatus may further comprise a means for causing a second at least one computer-readable storage medium different from the first at least one computer-readable storage medium to store the educational information in association with one of a second plurality of educational modules different from the first plurality of educational modules.

The means for causing the second at least one computer-readable storage medium to store may comprise a means for transmitting a third at least one signal to a second computer comprising the second at least one computer-readable storage medium.

The apparatus may further comprise: a means for receiving, from the first computer, a fourth at least one signal encoded with codes representing feedback associated with the one of the first plurality of educational modules; and a means for causing the first at least one computer-readable storage medium to store the feedback in association with the one of the first plurality of educational modules.

In accordance with another illustrative embodiment, there is provided an apparatus for distributing educational course content to a user of a first computer. The apparatus comprises: a communication interface configured to communicate with the first computer; a storage medium interface configured to communicate with a first at least one computer-readable storage medium; and a processor circuit in communication with the communication interface and the storage medium interface.

The processor circuit is configured to: retrieve educational information from the first at least one computer-readable storage medium comprising the educational information stored thereon in association with one of a first plurality of educational modules, wherein the educational information that the processor circuit is configured to retrieve from the first at least one computer-readable storage medium comprises at least one question, instructional information, and at least one explanation for a respective correct answer to a respective one of the at least one question; and cause the first computer to present the educational information retrieved from the first at least one computer-readable storage medium, wherein the processor circuit is configured to cause the first computer to present at least a portion of the instructional information while the at least one question is being presented by the first computer.

The processor circuit may be configured to cause the first computer to display text of the at least one question.

The processor circuit may be configured to cause the first computer to display the text of the at least one question on a display screen of the first computer.

The instructional information that the processor circuit is configured to retrieve from the first at least one computer-readable storage medium, and that the processor circuit is configured to cause the first computer to present, may comprise at least one visual image.

The processor circuit may be configured to cause the first computer to display the at least one visual image on the display screen of the first computer.

The processor circuit may be configured to cause the first computer to display the at least one visual image on the display screen of the first computer contemporaneously with the text of the at least one question.

The processor circuit may be configured to cause the first computer to present the at least one question on a left side of the display screen of the first computer and to present the at least one visual image on a right side of the display screen of the first computer.

The processor circuit may be configured to cause the first computer to present the at least one question on a right side of the display screen of the first computer and to present the at least one visual image on a left side of the display screen of the first computer.

The instructional information that the processor circuit is configured to retrieve from the first at least one computer-readable storage medium, and that the processor circuit is configured to cause the first computer to present, may comprise at least one audio recording of at least one lecture segment.

The processor circuit may be configured to cause the first computer to present the at least one audio recording in response to a request from the user of the first computer for presentation of the at least one audio recording.

The educational information that the processor circuit is configured to retrieve from the first at least one computer-readable storage medium, and that the processor circuit is configured to cause the first computer to present, may further comprise a plurality of possible answers to each one of the at least one question.

The processor circuit may be configured to cause the first computer to display text of the possible answers.

The processor circuit may be configured to cause the first computer to present the at least one question and the possible answers contemporaneously.

The processor circuit may be configured to cause the first computer to present the instructional information independently of any selection of any of the possible answers by the user of the first computer.

The processor circuit may be configured to cause the first computer to present the at least one explanation in response to a request from the user of the first computer for the at least one explanation.

The processor circuit may be configured to cause the first computer to display text of the at least one explanation.

The processor circuit may further be configured to cause the communication interface to transmit, to the first computer, a first at least one signal encoded with codes to cause the first computer to present the educational information.

The codes of the first at least one signal may comprise hypertext markup language codes.

The processor circuit may further be configured to cause the first at least one computer-readable storage medium to store the educational information in association with the one of the first plurality of educational modules.

The processor circuit may further be configured to receive the educational information.

The processor circuit may be configured to receive a second at least one signal encoded with codes representing the educational information associated with the one of the first plurality of educational modules.

The processor circuit may further be configured to cause the first at least one computer-readable storage medium to associate the one of the first plurality of educational modules with a first one of a plurality of lectures.

The processor circuit may further be configured to cause the first at least one computer-readable storage medium to associate the first one of the plurality of lectures with a first one of a plurality of courses.

The processor circuit may further be configured to cause the first at least one computer-readable storage medium to associate the one of the first plurality of educational modules with a second one of the plurality of lectures different from the first one of the plurality of lectures.

The processor circuit may further be configured to cause the first at least one computer-readable storage medium to associate a plurality of educational modules of the first plurality of educational modules with the first one of the plurality of lectures. The processor circuit may further be configured to cause the first at least one computer-readable storage medium to store thereon, in association with each one of the first plurality of educational modules associated with the first one of the plurality of lectures, a respective at least one question, respective instructional information, and a respective at least one explanation for a respective correct answer to a respective one of the respective at least one question.

The processor circuit may further be configured to cause a second at least one computer-readable storage medium different from the first at least one computer-readable storage medium to store the educational information in association with one of a second plurality of educational modules different from the first plurality of educational modules.

The processor circuit may further be configured to cause the communication interface to transmit a third at least one signal to a second computer comprising the second at least one computer-readable storage medium.

The processor circuit may further be configured to: receive, from the first computer, a fourth at least one signal encoded with codes representing feedback associated with the one of the first plurality of educational modules; and cause the first at least one computer-readable storage medium to store the feedback in association with the one of the first plurality of educational modules.

In accordance with another illustrative embodiment, there is provided a method of facilitating distribution of educational course content. The method comprises: receiving at least one signal encoded with codes representing educational information comprising at least one question, instructional information, and at least one explanation for a respective correct answer to a respective one of the at least one question; causing at least one computer-readable storage medium to store thereon the educational information in association with one of a first plurality of educational modules; and causing the at least one computer-readable storage medium to associate the one of the first plurality of educational modules with a first one of a plurality of lectures.

The instructional information may comprise at least one audio recording of at least one lecture segment.

The instructional information may comprise at least one visual image.

The educational information may further comprise a plurality of possible answers to each one of the at least one question.

The method may further comprise causing the at least one computer-readable storage medium to associate the first one of the plurality of lectures with a first one of a plurality of courses.

The method may further comprise causing the at least one computer-readable storage medium to associate the first one of the plurality of lectures with a second one of the plurality of courses different from the first one of the plurality of courses.

The method may further comprise causing the at least one computer-readable storage medium to associate the one of the first plurality of educational modules with a second one of the plurality of lectures different from the first one of the plurality of lectures.

The method may further comprise causing the at least one computer-readable storage medium to associate a plurality of educational modules of the first plurality of educational modules with the first one of the plurality of lectures such that the at least one computer-readable storage medium may comprise stored thereon, in association with each one of the first plurality of educational modules that is associated with the first one of the plurality of lectures, a respective at least one question, respective instructional information, and a respective at least one explanation for a respective correct answer to a respective one of the respective at least one question.

In accordance with another illustrative embodiment, there is provided at least one computer-readable storage medium comprising stored thereon program codes for directing at least one processor circuit to implement the method.

In accordance with another illustrative embodiment, there is provided an apparatus for distributing educational course content. The apparatus comprises: at least one processor circuit; and at least one computer-readable storage medium comprising stored thereon program codes for directing the at least one processor circuit to implement the method.

In accordance with another illustrative embodiment, there is provided an apparatus for facilitating distribution of educational course content. The apparatus comprises: a means for receiving at least one signal encoded with codes representing educational information comprising at least one question, instructional information, and at least one explanation for a respective correct answer to a respective one of the at least one question; a means for causing at least one computer-readable storage medium to store thereon the educational information in association with one of a first plurality of educational modules; and a means for causing the at least one computer-readable storage medium to associate the one of the first plurality of educational modules with a first one of a plurality of lectures.

The instructional information may comprise at least one audio recording of at least one lecture segment.

The instructional information may comprise at least one visual image.

The educational information may further comprise a plurality of possible answers to each one of the at least one question.

The apparatus may further comprise a means for causing the at least one computer-readable storage medium to associate the first one of the plurality of lectures with a first one of a plurality of courses.

The apparatus may further comprise a means for causing the at least one computer-readable storage medium to associate the first one of the plurality of lectures with a second one of the plurality of courses different from the first one of the plurality of courses.

The apparatus may further comprise a means for causing the at least one computer-readable storage medium to associate the one of the first plurality of educational modules with a second one of the plurality of lectures different from the first one of the plurality of lectures.

The apparatus may further comprise a means for causing the at least one computer-readable storage medium to associate a plurality of educational modules of the first plurality of educational modules with the first one of the plurality of lectures. The means for causing the first at least one computer-readable storage medium to associate may be configured to cause the at least one computer-readable storage medium to store thereon, in association with each one of the first plurality of educational modules that is associated with the first one of the plurality of lectures, a respective at least one question, respective instructional information, and a respective at least one explanation for a respective correct answer to a respective one of the respective at least one question.

In accordance with another illustrative embodiment, there is provided an apparatus for facilitating distribution of educational course content. The apparatus comprises: a communication interface configured to communicate with a computer; a storage medium interface configured to communicate with at least one computer-readable storage medium; and a processor circuit in communication with the communication interface and the storage medium interface. The processor circuit is configured to: receive, over the communication interface, at least one signal encoded with codes representing educational information comprising at least one question, instructional information, and at least one explanation for a respective correct answer to a respective one of the at least one question; cause the at least one computer-readable storage medium to store thereon the educational information in association with one of a first plurality of educational modules; and cause the at least one computer-readable storage medium to associate the one of the first plurality of educational modules with a first one of a plurality of lectures.

The instructional information may comprise at least one audio recording of at least one lecture segment.

The instructional information may comprise at least one visual image.

The educational information may further comprise a plurality of possible answers to each one of the at least one question.

The processor circuit may further be configured to cause the at least one computer-readable storage medium to associate the first one of the plurality of lectures with a first one of a plurality of courses.

The processor circuit may further be configured to cause the at least one computer-readable storage medium to associate the first one of the plurality of lectures with a second one of the plurality of courses different from the first one of the plurality of courses.

The processor circuit may further be configured to cause the at least one computer-readable storage medium to associate the one of the first plurality of educational modules with a second one of the plurality of lectures different from the first one of the plurality of lectures.

The processor circuit may further be configured to cause the at least one computer-readable storage medium to associate a plurality of educational modules of the first plurality of educational modules with the first one of the plurality of lectures. The processor circuit may further be configured to cause the at least one computer-readable storage medium to store thereon, in association with each one of the first plurality of educational modules that is associated with the first one of the plurality of lectures, a respective at least one question, respective instructional information, and a respective at least one explanation for a respective correct answer to a respective one of the respective at least one question.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings of illustrative embodiments:

FIG. 1 is a schematic illustration of an educational course content distribution system according to an illustrative embodiment;

FIG. 2 is a schematic illustration of a computer of the educational course content distribution system of FIG. 1;

FIG. 3 is an entity-relationship diagram of a database of the computer of FIG. 2;

FIG. 4 is a schematic illustration of a user table entry of the database of FIG. 3;

FIG. 5 is a schematic illustration of a course table entry of the database of FIG. 3;

FIG. 6 is a schematic illustration of a registration table entry of the database of FIG. 3;

FIG. 7 is a schematic illustration of a lecture table entry of the database of FIG. 3;

FIG. 8 is a schematic illustration of an educational module table entry of the database of FIG. 3;

FIG. 9 is a schematic illustration of a question table entry of the database of FIG. 3;

FIG. 10 is a schematic illustration of a question included table entry of the database of FIG. 3;

FIG. 11 is a schematic illustration of an answer table entry of the database of FIG. 3;

FIG. 12 is a schematic illustration of a feedback table entry of the database of FIG. 3;

FIG. 13 is an illustration of a homepage defined by a user interface of the computer of FIG. 2;

FIG. 14 is an illustration of a teacher homepage defined by the user interface of the computer of FIG. 2;

FIG. 15 is an illustration of an educational information editing page defined by the user interface of the computer of FIG. 2;

FIG. 16 is an illustration of a lecture edit page defined by the user interface of the computer of FIG. 2;

FIG. 17 is an illustration of an add educational module page defined by the user interface of the computer of FIG. 2;

FIG. 18 is a schematic illustration of create educational module program codes of a program memory of the computer of FIG. 2;

FIG. 19 is a schematic illustration of a question information message received by the create educational module program codes of FIG. 18;

FIG. 20 is a schematic illustration of an image information message received by the create educational module program codes of FIG. 18;

FIG. 21 is a schematic illustration of an audio information message received by the create educational module program codes of FIG. 18;

FIG. 22 is an illustration of a course information page defined by the user interface of the computer of FIG. 2;

FIG. 23 is an illustration of a transfer page defined by the user interface of the computer of FIG. 2;

FIG. 24 is a schematic illustration of transfer educational module program codes of the program memory of the computer of FIG. 2;

FIG. 25 is a schematic illustration of a transfer information message received by the transfer educational module program codes of FIG. 24;

FIG. 26 is a schematic illustration of a transmit message generated by the transfer educational module program codes of FIG. 24;

FIG. 27 is an illustration of a student homepage defined by the user interface of the computer of FIG. 2;

FIG. 28 is an illustration of a join course page defined by the user interface of the computer of FIG. 2;

FIG. 29 is a schematic illustration of distribute educational course content program codes of the program memory of the computer of FIG. 2;

FIG. 30 is an illustration of an educational module student display page defined by the user interface of the computer of FIG. 2;

FIG. 31 is an illustration of a share feedback page defined by the user interface of the computer of FIG. 2; and

FIG. 32 is a schematic illustration of a feedback message received by receive feedback program codes of the program memory of the computer of FIG. 2.

### DETAILED DESCRIPTION

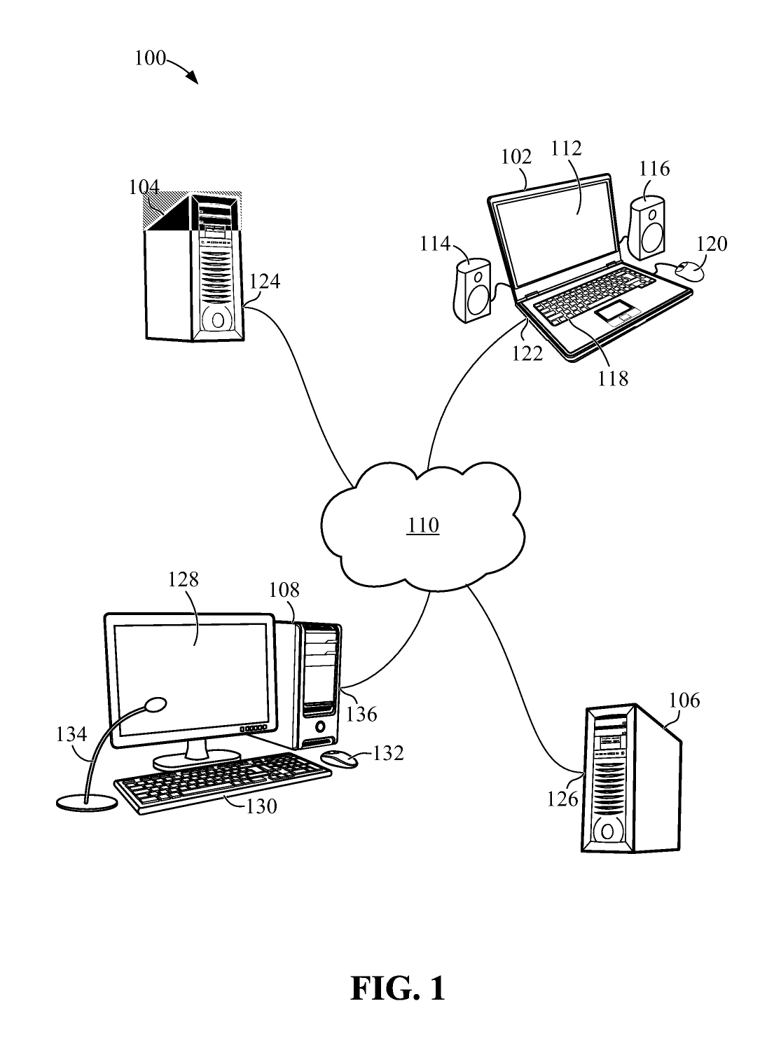

Referring to FIG. 1, an educational course content distribution system according to an illustrative embodiment is shown generally at 100. The educational course content distribution system 100 includes computers 102, 104, 106, and 108, all of which are in communication with each other, and with numerous other computers (not shown), over various components of the internet shown generally at 110.

In the embodiment shown, the computer 102 is a laptop personal computer having a display screen 112, audio speakers 114 and 116, and input devices including a keyboard 118 and a mouse 120. The computer 102 also includes an internet interface 122 for communicating with various other computers (such as the computer 106 for example) over the internet 110. The computer 102 may communicate with such other computers over the internet 110 using various components such as wired or wireless components, for example. In general, the computer 102 includes various hardware and software components that enable the computer 102 to perform various functions of a personal computer, such as an operating system and a World Wide Web (“WWW”) browser application that allow a student user (not shown) of the computer 102 to access and interact with various WWW pages using hyper text transfer protocol (“HTTP”). Although the computer 102 in the embodiment shown is a laptop personal computer, alternative embodiments may include tablets, smart phones, and other apparatuses that enable a student user of such an apparatus to perform similar functions.

The computers 104 and 106 have respective internet interfaces 124 and 126 (or, more generally, communication interfaces) that allow the computers 104 and 106 to communicate with other computers over the internet 110 using wired or wireless components for example, and generally the computers 104 and 106 function as WWW servers for various computers including the computers 102 and 108 as described below.

The computer 108 in the embodiment shown is a personal computer including a display screen 128, input devices including a keyboard 130, a mouse 132, and an audio microphone 134, and an internet interface 136 that allows the computer 108 to communicate over the internet 110. Again, the computer 108 may communicate with various other computers (such as the computer 106 for example) over the internet 110 using wired or wireless components for example. Also, the computer 108 includes various hardware and software components that enable the computer 108 to perform various functions of a personal computer, such as an operating system and a WWW browser application that allow a teacher user (not shown) of the computer 108 to access and interact with various WWW pages using HTTP. Again, although the computer 108 in the embodiment shown is a personal computer, alternative embodiments may include tablets, smart phones, and other apparatuses that enable a teacher user of such an apparatus to perform similar functions.

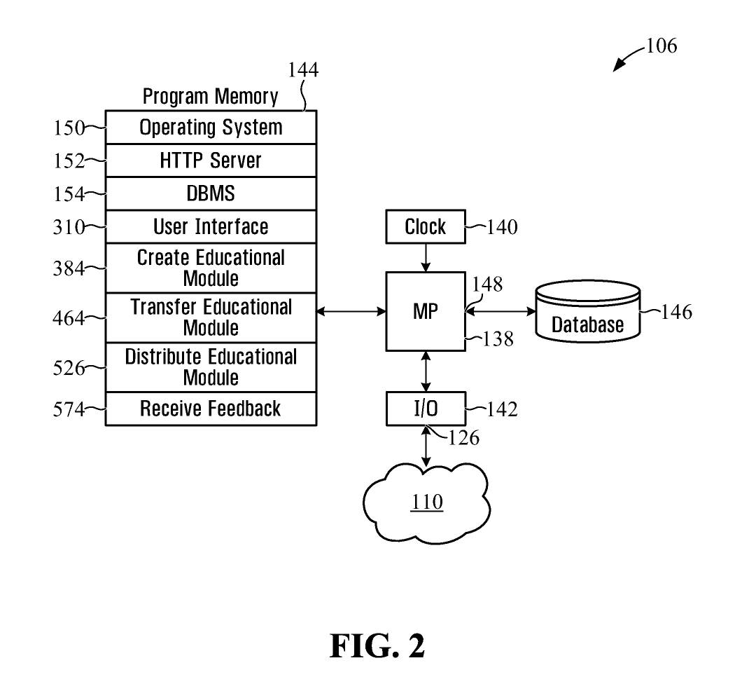

Referring to FIG. 2, the computer 106 includes a processor circuit, which in the embodiment shown includes a microprocessor 138. The computer 106 also includes a clock 140, an input/output (“I/O”) interface 142, a program memory 144, and a database 146 all in communication with the microprocessor 138. The microprocessor 138 communicates with the database 146 at a storage medium interface 148. The clock 140 maintains values representing a current date and time, and provides such values to the microprocessor 138 from time to time for storage in various stores in the database 146 as described below. The I/O interface 142 includes the internet interface 126 (also shown in FIG. 1) and facilitates communicating with the internet 110 over various network components. The program memory 144 and the database 146 may be implemented on one or more of the same or different computer-readable storage media, which in various embodiments may include one or more of a read-only memory (“ROM”), random access memory (“RAM”), a hard disc drive (“HDD”), and other computer-readable and/or -writable storage media. Further, in alternative embodiments (not shown), the computer 106 may be partly or fully implemented using different hardware logic, which may include discrete logic circuits and/or an application specific integrated circuit (“ASIC”) for example.

The program memory 144 generally includes codes for directing the microprocessor 138 to execute various functions of the computer 106. The program memory 144 includes various blocks of code, including operating system codes 150 of an operating system for the computer 106. The program memory 144 also includes HTTP server codes 152, which include codes for an HTTP server to make various HTML and/or other documents available to users of the computer 106 over the internet 110, such as to respective users of the computers 102 and 108 (shown in FIG. 1) in the embodiment shown. The program memory 144 also includes database management system (“DBMS”) codes 154 generally for managing the database 146 as described in further detail below.

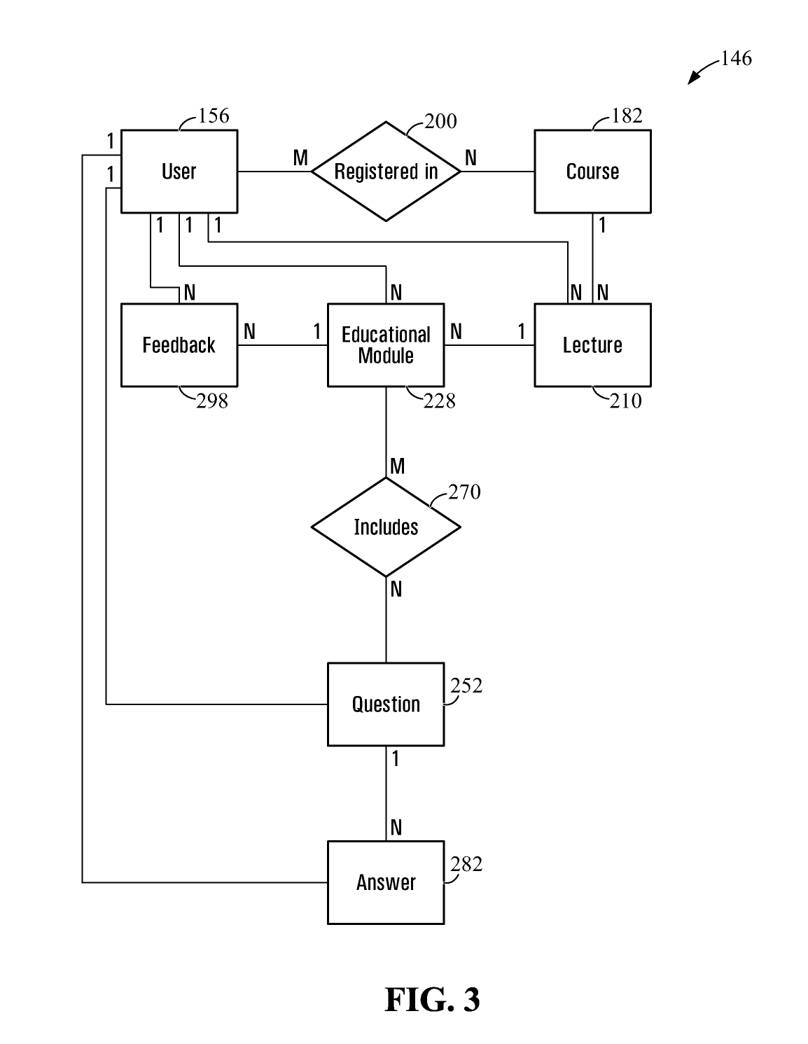

Referring to FIG. 3, the database 146 in the embodiment shown is a relational database including a plurality of tables. The various tables of the database 146 can each store instances of various table entries as described below. The various table entries each include various fields, and an instance of such a table entry can store particular values in such fields.

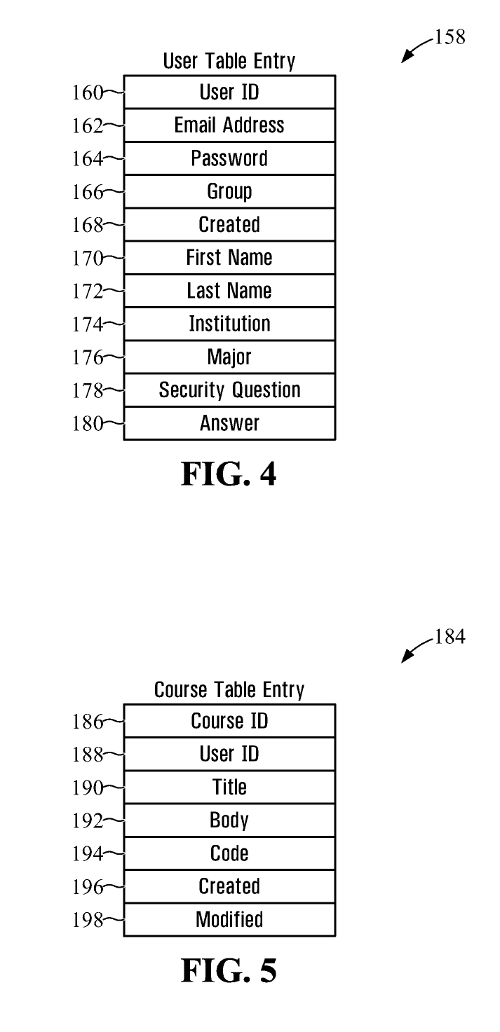

The database 146 includes a user table 156 that can store any number of instances of a user table entry shown generally at 158 in FIG. 4. In general, each instance of the user table entry 158 is associated with a user of the computer 106 (shown in FIGS. 2 and 3), which in the embodiment shown may include a student user of the computer 102 (shown in FIG. 1) and a teacher user of the computer 108 (shown in FIG. 1).

Referring to FIGS. 3 and 4, the user table entry 158 includes a user identifier field 160, which in the embodiment shown stores an integer assigned by the DBMS codes 154 (shown in FIG. 2) to identify an instance of the user table entry 158 uniquely in the user table 156. The user table entry 158 also includes an email address field 162, which in the embodiment shown stores an electronic mail address of a user associated with an instance of the user table entry 158. The user table entry 158 also includes a password field 164, and a user associated with an instance of the user table entry 158 can sign on to a session with the computer 106 using the email address and password stored in the email address field 162 and the password field 164 respectively. The password field 164 may store an encrypted password for greater security in some embodiments. The user table entry 158 also includes a group field 166, which in the embodiment shown stores a representation of whether a user associated with an instance of the user table entry 158 is a student or a teacher. The user table entry 158 also includes a created field 168, which stores a representation of a time retrieved from the clock 140 (shown in FIG. 2) when an instance of the user table entry 158 is created. The user table entry 158 also includes a first name field 170 and a last name field 172, which store representations of a first name and a last name respectively of a user associated with an instance of the user table entry 158. The user table entry 158 also includes an institution field 174, which stores a representation of an institution (such as a university, college, or other post-secondary education institution, for example) that a user associated with an instance of the user table entry 158 attends as a student or teaches at as a teacher. The user table entry 158 also includes a major field 176 which stores a major (or other educational program information) of a user associated with an instance of the user table entry 158 when that user is a student. The user table entry 158 also includes a security question field 178 and an answer field 180 to store a security question and associated answer that may verify the identity of a user associated with an instance of a user table entry 158 if, for example, the user is unable to enter correctly the password represented in the password field 164.

Referring back to FIG. 3, the database 146 also includes a course table 182 that can store any number of instances of a course table entry shown generally at 184 in FIG. 5. In general, each instance of the course table entry 184 is associated with a course offered using the computer 106 (shown in FIGS. 2 and 3) to students, such as to a student user of the computer 102 (shown in FIG. 1) in the embodiment shown.

Referring to FIGS. 3 and 5, the course table entry 184 includes a course identifier field 186, which in the embodiment shown stores an integer assigned by the DBMS codes 154 (shown in FIG. 2) to identify an instance of the course table entry 184 uniquely in the course table 182. The course table entry 184 also includes a user identifier field 188 for storing a user identifier from the user identifier field 160 of an instance of the user table entry 158 (shown in FIG. 4) associated with a user who is a teacher (or more generally, an owner) of a course associated with an instance of the course table entry 184. The course table entry 184 also includes a title field 190 for storing a title of a course associated with an instance of the course table entry 184, and a body field 192 for storing a text description of a course associated with an instance of the course table entry 184. The course table entry 184 also includes a course code field 194, which stores an alphanumeric course code that a teacher may transmit (by email, for example) to one or more students that that the students may use to access or otherwise identify a course associated with an instance of the course table entry 184. The course table entry 184 also includes a created field 196 and a modified field 198, which store respective representations of a respective date and time retrieved from clock 140 (shown in FIG. 2) when an instance of the course table entry 184 was created and modified respectively.

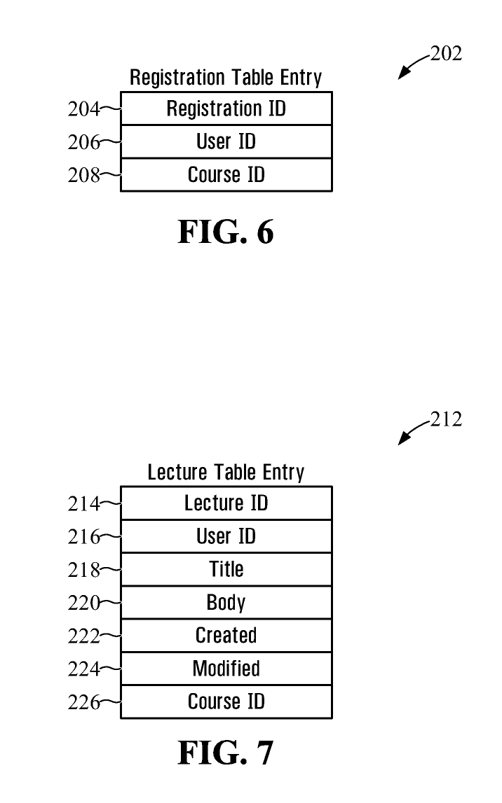

Referring back to FIG. 3, the database 146 also includes a registration table 200 that can store any number of instances of a registration table entry shown generally at 202 in FIG. 6. Referring to FIGS. 3 and 6, the registration table entry 202 includes a registration identifier field 204, which in the embodiment shown stores an integer assigned by the DBMS codes 154 (shown in FIG. 2) to identify an instance of the registration table entry 202 uniquely in the registration table 200. The registration table entry 202 also includes a user identifier field 206 for storing a user identifier from the user identifier field 160 of an instance of the user table entry 158 (shown in FIG. 4), and a course identifier field 208 for storing a course identifier from the course identifier field 186 of an instance of the course table entry 184 (shown in FIG. 5). Therefore, in general, each instance of the registration table entry 202 represents registration of a user associated with an instance of the user table entry 158 (shown in FIG. 4) identified by the user identifier field 206 in a course associated with an instance of the course table entry 184 (shown in FIG. 5) identified by the course identifier field 208.

Referring back to FIG. 3, the database 146 also includes a lecture table 210 that can store any number of instances of a lecture table entry shown generally at 212 in FIG. 7. In general, each instance of the lecture table entry 212 is associated with a lecture that is part of a course associated with an instance of the course table entry 184 (shown in FIG. 5).

Referring to FIGS. 3 and 7, the lecture table entry 212 includes a lecture identifier field 214, which in the embodiment shown stores an integer assigned by the DBMS codes 154 (shown in FIG. 2) to identify an instance of the lecture table entry 212 uniquely in the lecture table 210. The lecture table entry 212 also includes a user identifier field 216 for storing a user identifier from the user identifier field 160 of an instance of the user table entry 158 (shown in FIG. 4) associated with a user that is the teacher (or more generally, the owner) of a lecture associated with an instance of the lecture table entry 212. The lecture table entry 212 also includes a title field 218, which stores text of a title of a lecture associated with an instance of the lecture table entry 212. The lecture table entry 212 also includes a body field 220, which stores text of a description of a lecture associated with an instance of the lecture table entry 212. The lecture table entry 212 also includes a created field 222 and a modified field 224, which store respective representations of a respective date and time retrieved from the clock 140 (shown in FIG. 2) when an instance of the lecture table entry 212 was created and modified respectively. The lecture table entry 212 also includes a course identifier field 226 for storing a course identifier from the course identifier field 186 of an instance of the course table entry 184 (shown in FIG. 5) associated with a course that includes a lecture associated with an instance of the lecture table entry 212. In other words, one or more lectures may be associated with a particular course in the database 146 if the course identifier in the course identifier field 226 of the lecture table entries 212 associated with those lectures identifies an instance of the course table entry 184 (shown in FIG. 5) associated with that particular course.

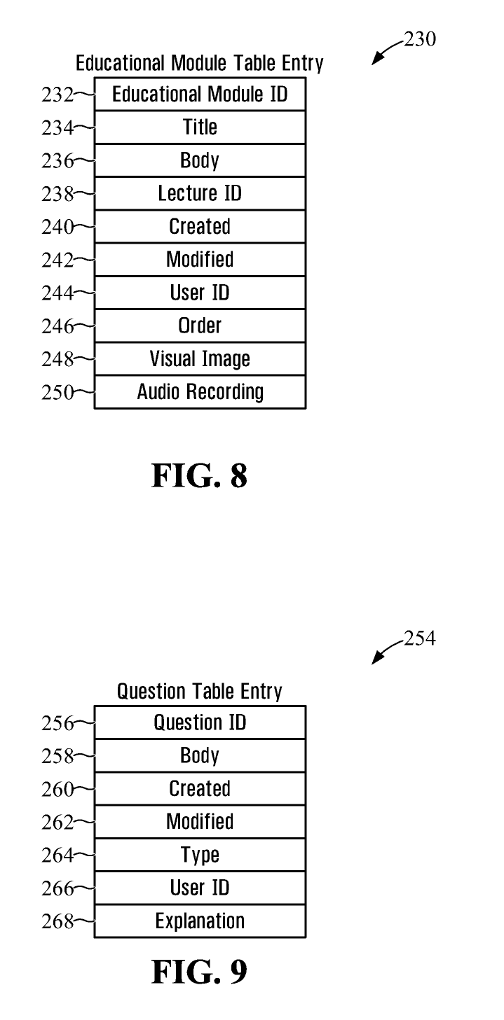

Referring back to FIG. 3, the database 146 also includes an educational module table 228 that can store any number of instances of an educational module entry shown generally at 230 in FIG. 8. In general, each instance of the educational module table entry 230 is associated with an educational module that is part of a lecture associated with an instance of the lecture table entry 212 (shown in FIG. 7).

Referring to FIGS. 3 and 8, the educational module table entry 230 includes an educational module identifier field 232, which in the embodiment shown includes an integer assigned by the DBMS codes 154 (shown in FIG. 2) to identify an instance of the educational module table entry 230 uniquely in the educational module table 228. The educational module table entry 230 also includes a title field 234 for storing text of a title of an educational module associated with an instance of the educational module table entry 230, and a body field 236 for storing text of a description of an educational module associated with an instance of the educational module table entry 230. The educational module table entry 230 also includes a lecture identifier field 238 for storing a lecture identifier from the lecture identifier field 214 of an instance of a lecture table entry 212 (shown in FIG. 7) including an educational module associated with an instance of the educational module table entry 230. In other words, one or more educational modules may be associated with a particular lecture if the lecture identifier field 238 of the instances of the educational module table entry 230 associated with such educational modules identifies an instance of the lecture table entry 212 (shown in FIG. 7) associated with that particular lecture. The educational module table entry 230 also includes a created field 240 and a modified field 242 for storing respective representations of a respective date and time retrieved from the clock 140 (shown in FIG. 2) when an instance of the educational module table entry 230 was created and modified respectively. The educational module table entry 230 also includes a user identifier field 244 for storing a user identifier from the user identifier field 160 of an instance of user table entry 158 (shown in FIG. 4) associated with a user that is a teacher (or more generally, an owner) of an educational module associated with an instance of the educational module table entry 230. The educational module table entry 230 also includes an order field 246, which in the embodiment shown stores a positive integer representing the order (or sequence) of an educational module associated with an instance of the educational module table entry 230 in a lecture associated with the instance of the lecture table entry 212 (shown in FIG. 7) identified by the lecture identifier field 238. In other words, as indicated above, one or more educational modules may be associated with a particular lecture, and the value stored in the order field 246 represents the order (or sequence) of each educational module associated with that lecture. The educational module table entry 230 also includes a visual image field 248 for storing at least one visual image associated with an educational module associated with an instance of the educational module table entry 230. The educational module table entry 230 also includes an audio recording field 250 for storing at least one audio recording associated with an educational module associated with an instance of the educational module table entry 230.

Referring back to FIG. 3, the database 146 also includes a question table 252 for storing any number of instances of a question table entry shown generally at 254 in FIG. 9. In general, each instance of the question table entry 254 is associated with a question that is part of an educational module associated with an instance of the educational module table entry 230 (shown in FIG. 8).

Referring to FIGS. 3 and 9, the question table entry 254 includes a question identifier field 256, which in the embodiment shown stores an integer assigned by the DBMS codes 154 (shown in FIG. 2) to identify an instance of the question table entry 254 uniquely in the question table 252. The question table entry 254 also includes a body field 258 for storing text of a question associated with an instance of the question table entry 254. The question table entry 254 also includes a created field 260 and a modified field 262 for storing respective representations of a respective date and time retrieved from the clock 140 (shown in FIG. 2) representing when an instance of the question table entry 254 was created and modified respectively. The question table entry 254 also includes a type field 264, which in the embodiment shown stores a representation of whether a question associated with an instance of the question table entry 254 is a multiple choice question or a short answer question. The question table entry 254 also includes a user identifier field 266 for storing a user identifier from the user identifier field 160 of an instance of the user table entry 158 (shown in FIG. 4) associated with a user that is a teacher (or more generally, an owner) associated with a question associated with an instance of the question table entry 254. The question table entry 254 also includes an explanation field 268 for storing text of an explanation for a correct answer to a question associated with an instance of the question table entry 254.

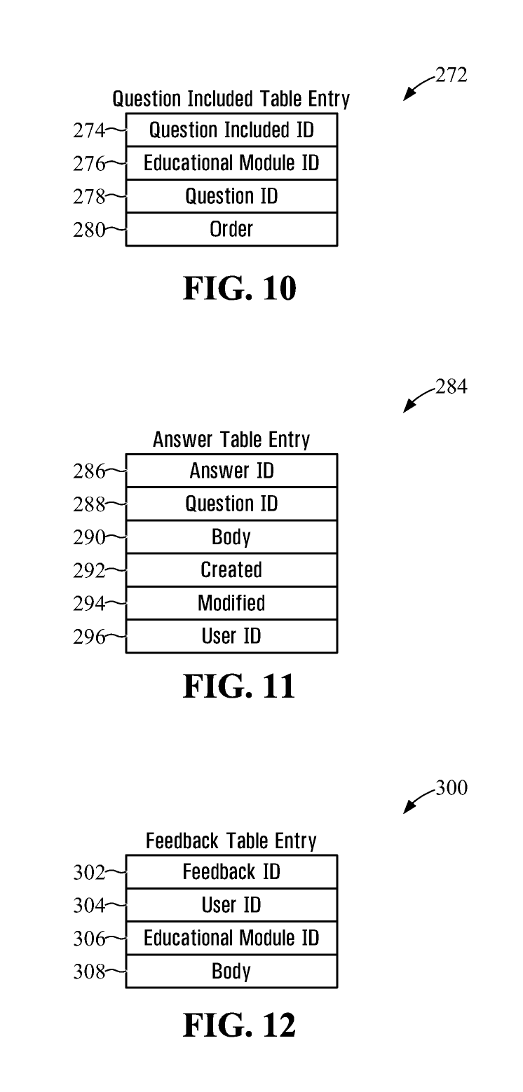

Referring back to FIG. 3, the database 146 also includes a question included table 270 for storing any number of instances of a question included table entry shown generally at 272 in FIG. 10.

Referring to FIGS. 3 and 10, the question included table entry 272 includes a question included identifier field 274, which in the embodiment shown stores an integer assigned by the DBMS codes 154 (shown in FIG. 2) to identify an instance of the question included table entry 272 uniquely in the question included table 270. The question included table entry 272 also includes an education module identifier field 276 for storing an educational module identifier from the educational module identifier field 232 of an instance of the educational module table entry 230 (shown in FIG. 8). The question included table entry 272 also includes a question identifier field 278 for storing a question identifier from the question identifier field 256 of an instance of the question table entry 254 (shown in FIG. 9). Therefore, in general, each instance of the question included table entry 272 associates a question associated with an instance of the question table entry 254 (shown in FIG. 9) identified by the question identifier in the question identifier field 278 with an educational module associated with an instance of the educational module table entry 230 (shown in FIG. 8) identified by the educational module identifier field 276, and therefore the question included table 270 allows one or more questions associated with respective instances of the question table entry 254 (shown in FIG. 9) to be associated with a particular educational module associated with a particular instance of the educational module table entry 230 (shown in FIG. 8). The question included table entry 272 also includes an order field 280 for storing a positive integer representing the order (or sequence) of the question associated with the instance of the question table entry 254 (shown in FIG. 9) identified by the question identifier field 278 in the educational module identified by the educational module table entry 230 (shown in FIG. 8) identified by the educational module identifier field 276. In other words, one or more questions may be associated with a particular educational module by respective instances of the question included table entry 272, and the value of the order field 280 in those question included entries identifies the order of each such question in the particular educational module.

Referring back to FIG. 3, the database 146 also includes an answer table 282 for storing any number of instances of an answer table entry shown generally at 284 in FIG. 11. In general, each instance of the answer table entry 284 is associated with an answer to a question associated with an instance of the question table entry 254 (shown in FIG. 9).

Referring to FIGS. 3 and 11, the answer table entry 284 includes an answer identifier field 286, which in the embodiment shown stores an integer assigned by the DBMS codes 154 (shown in FIG. 2) to identify an instance of the answer table entry 284 uniquely in the answer table 282. The answer table entry 284 also includes a question identifier field 288 for storing a question identifier from the question identifier field 256 of an instance of the question table entry 254 (shown in FIG. 9). In other words, an answer associated with an instance of the answer table entry 284 may be associated with a question associated with an instance of the question table entry 254 (shown in FIG. 9) identified by the question identifier field 288. The answer table entry 284 also includes a body field 290 for storing text of an answer associated with an instance of the answer table entry 284. The answer table entry 284 also includes a created field 292 and a modified field 294 for storing respective values representing a respective date and time retrieved from the clock 140 (shown in FIG. 2) representing when an instance of the answer table entry 284 was created and modified respectively. The answer table entry 284 also includes a user identifier field 296 for storing a user identifier from the user identifier field 160 of an instance of the user table entry 158 (shown in FIG. 4) associated with a user that is a teacher (or more generally an owner) of an instance of the answer table entry 284.

Referring back to FIG. 3, the database 146 also includes a feedback table 298 for storing any number of instances of a feedback table entry shown generally at 300 in FIG. 12. In general, each instance of the feedback table entry 300 is associated with particular feedback text that is from a user associated with an instance of the user table entry 158 (shown in FIG. 4) and that is regarding an educational module associated with an instance of the educational module table entry 230 (shown in FIG. 8).

Referring to FIGS. 3 and 12, the feedback table entry 300 includes a feedback identifier field 302, which in the embodiment shown stores an integer assigned by the DBMS codes 154 (shown in FIG. 2) to identify an instance of the feedback table entry 300 uniquely in the feedback table 298. The feedback table entry 300 also includes a user identifier field 304 for storing a user identifier from the user identifier field 160 of an instance of the user table entry 158 (shown in FIG. 4) associated with a user who left feedback associated with an instance of the feedback table entry 300. The feedback table entry 300 also includes an educational module identifier field 306 for storing an educational module identifier from the education module identifier field 232 of an instance of the educational module table entry 230 (shown in FIG. 8) associated with an educational module for which the feedback associated with an instance of the feedback table entry 300 was left. The feedback table entry 300 also includes a body field 308 including text of feedback associated with an instance of feedback table entry 300.

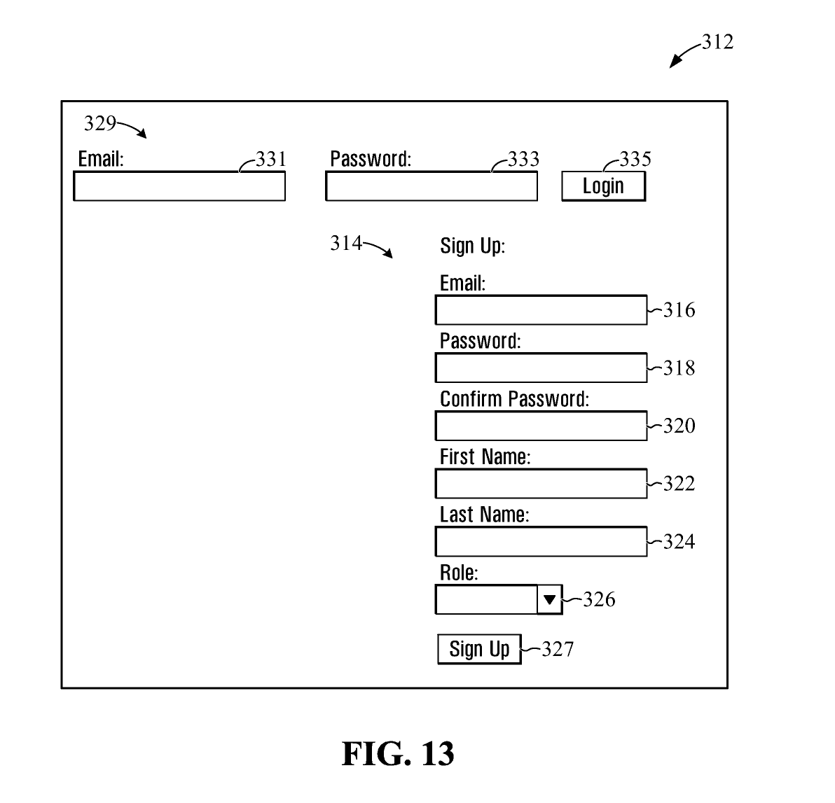

Referring back to FIG. 2, the program memory 144 also includes user interface codes 310 for communicating with various user interfaces for users of the computer 106. For example, in the embodiment shown, the user interface codes 310 include various codes (such as HTML codes and scripts and applications for producing HTML codes) to enable users of the computers 102 and 108 (shown in FIG. 1) to interact with the computer 106 in various ways. For example, referring back to FIG. 1, if a user of one of the computers 102 and 108 in the embodiment shown directs a WWW browser application of the computer 102 or 106 to a homepage of a WWW site maintained by the computer 106, then the computer 102 or 108 receives various codes from the computer 106 to cause the WWW browser application of the computer 102 or 108 to display the homepage as defined by codes of the user interface codes 310 (shown in FIG. 2) and shown generally at 312 in FIG. 13.

Referring to FIG. 13, the homepage 312 includes a sign-up region shown generally at 314 and including an email address input field 316, a password input field 318, a confirm password input field 320, a first name input field 322, a last name input field 324, a role input field 326, and a sign-up button 327. The input fields 316, 318, 320, 322, and 324 receive text input by a user, and the role input field 326 allows a user to select an input representing a student role or a teacher role. When the user selects the sign-up button 327, the user interface codes 310 direct the DBMS codes 154 (shown in FIG. 2) to store a new instance of the user table entry 158 (shown in FIG. 4) in the database 146 (shown in FIGS. 2 and 3).

Referring to FIGS. 4 and 13, the email address field 162 of the new instance of the user table entry 158 stores a value of an email address received from the email address input field 316, the password field 164 of the new instance of the new user table entry 158 stores a password received in both the password input field 318 and the confirm password input field 320, the first name field 170 and the last name field 172 of the new instance of the user table entry 158 include values received from the first name input field 322 and the last name input field 324 respectively, and the group field 166 of the new instance of the user table entry 158 stores a representation of the selection of either a student role or a teacher role in the role input field 326. The remaining fields of the new instance of the user table entry 158 may be established by other input fields not shown, or by an administrator of the computer 106 for example.

Referring back to FIG. 13, the homepage 312 also includes a sign-in region shown generally at 329, which includes an email input field 331, a password input field 333, and a sign-in button 335. Once a user has signed up using the sign-up region 314, the user may subsequently sign in to a session using the sign-in region 329. In general, once a user signs in, the user interface codes 310 (shown in FIG. 2) establish and maintain a session identifier that identifies the session of the user. For example, from time to time, the computer 102 or 108 may transmit one or more signals to the computer 106 in a particular session initiated by a particular user, and such signals may include a session identifier established by the user interface codes 310 to allow the computer 106 to identify the user associated with the session, or more generally to allow the computer 106 to identify other information associated with the particular session.

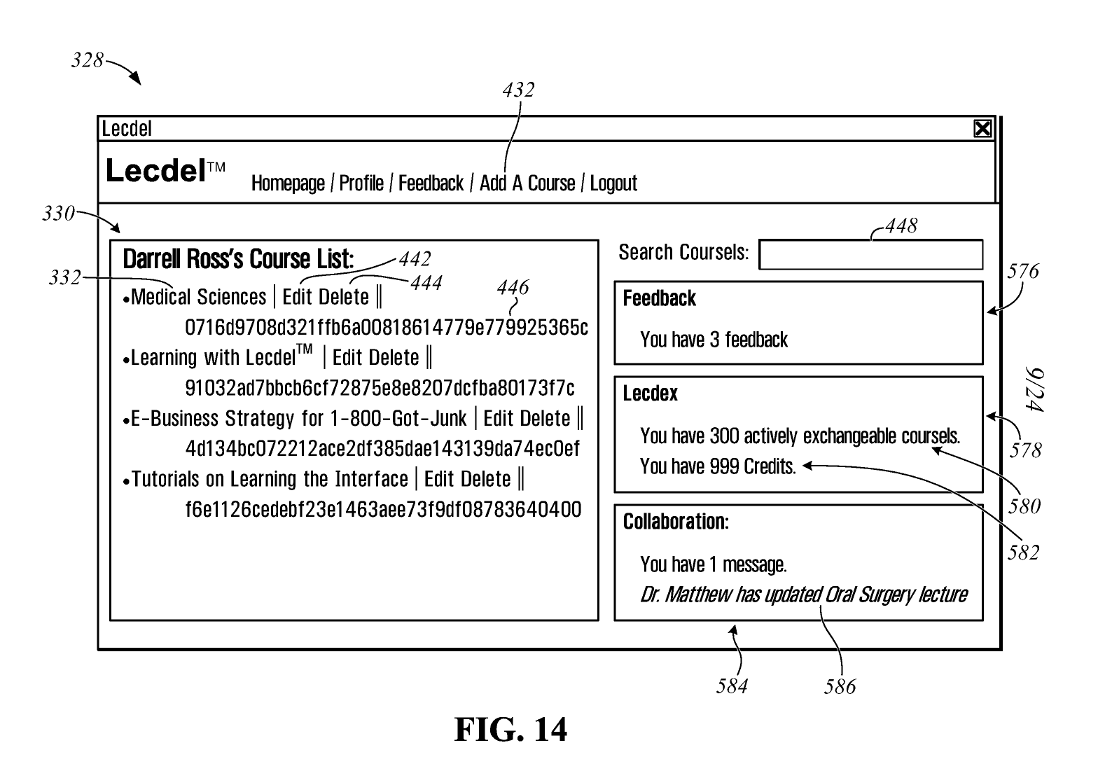

Referring to FIGS. 1 and 13, in the embodiment shown, the user of the computer 108 that completes the sign-in region 329 is a teacher, and the user interface codes 310 (shown in FIG. 2) transmit codes to the computer 108 to cause the WWW browser application of the computer 108 to display on the display screen 128 a teacher homepage shown generally at 328 in FIG. 14.

Referring to FIG. 14, the teacher homepage 328 includes a course listing region shown generally at 330 and listing courses associated with the course table entries 184 having user identifier fields 188 (shown in FIG. 5) identifying the user that signed in using the sign-in region 329 (shown in FIG. 13). In the embodiment shown, the course listing region 330 includes four courses, namely one entitled “Medical Sciences”, one entitled “Learning with Lecdel™”, one entitled “E-business Strategy for 1-800-Got-Junk”, and one entitled “Tutorials on Learning the Interface”.

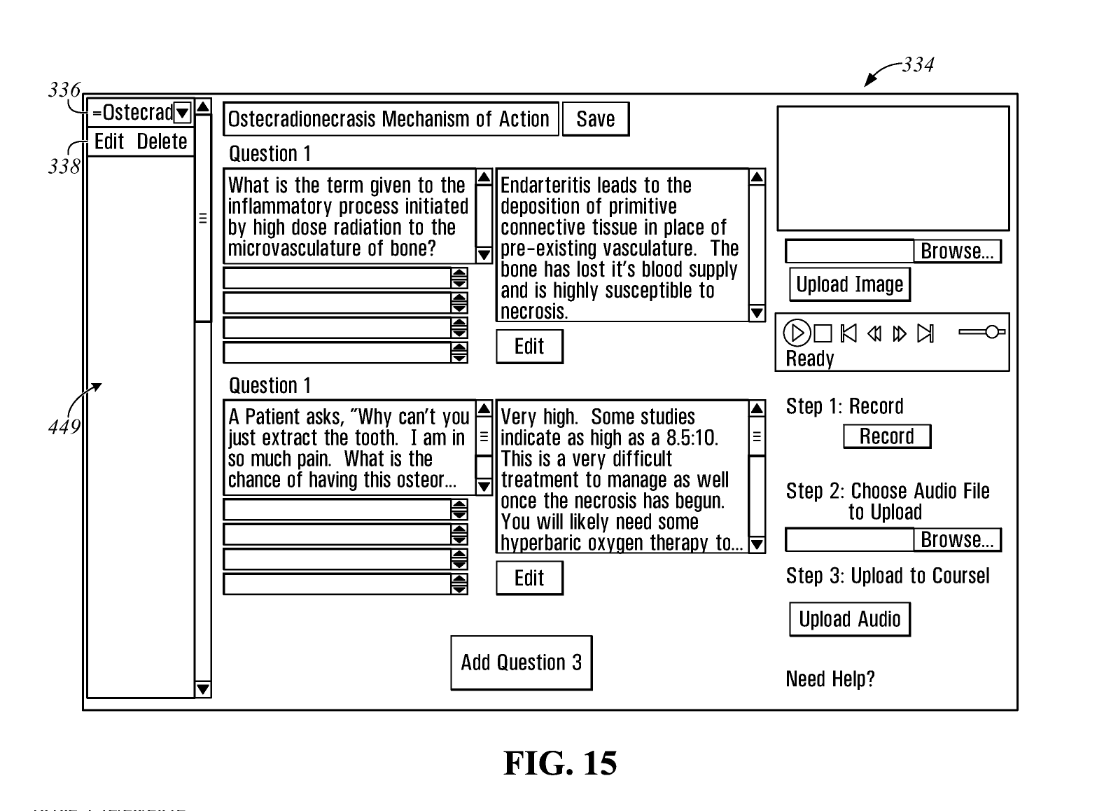

Referring to the course entitled “Medical Sciences” as an example, the course listing region 330 includes a hyperlink 332, and if the user clicks on the hyperlink 332, then the user interface codes 310 (shown in FIG. 2) cause the computer 106 to transmit codes to the computer 108 to cause a WWW application on the computer 108 to display on the display screen 128 an educational information editing page shown generally at 334 in FIG. 15 and associated with the “Medical Sciences” course in the embodiment shown.

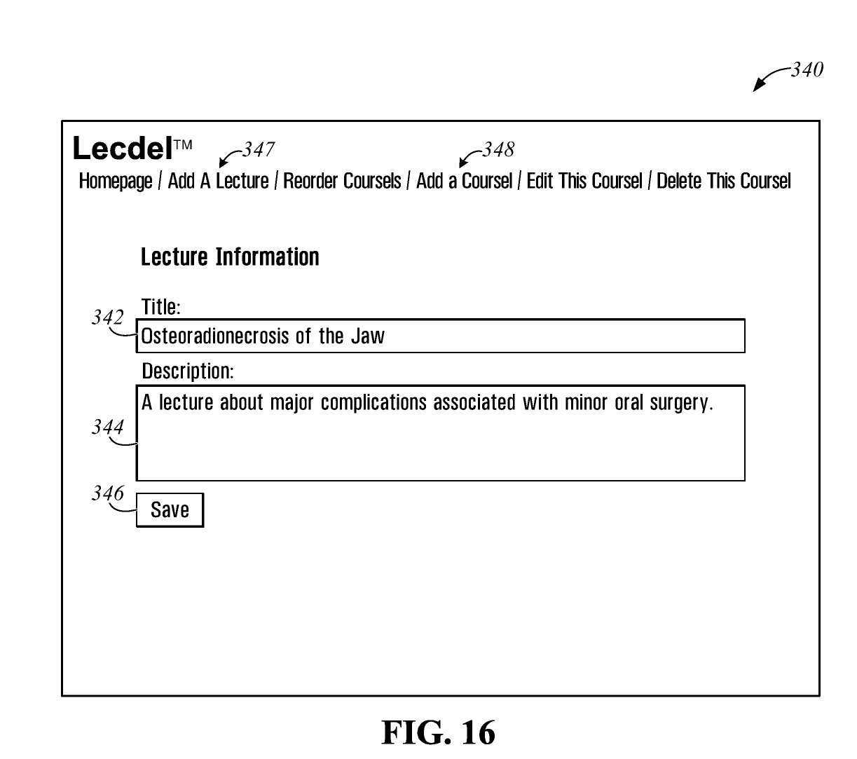

Referring to FIG. 15, the educational information editing page 334 includes a lecture selection field 336 to allow a user of the computer 108 to select one of the lectures associated with the course that is associated with the educational information editing page 334. In other words, in the embodiment shown, the educational information editing page 334 is associated with a particular course that is associated with a particular instance of the course table entry 184 (shown in FIG. 5), and the lecture selection field 336 includes a drop down list including items for each of the lectures that are associated with instances of lecture table entries 212 having course identifier fields 226 (shown in FIG. 7) that identify the particular instance of the course table entry 184. The educational information editing page 334 also includes an edit hyperlink 338, which, when selected by the user, directs the WWW browser application to a lecture edit page shown generally at 340 in FIG. 16.

Referring to FIG. 16, the lecture edit page 340 includes a title input field 342, a description input field 344, and a save button 346. When the user selects the save button 346, text from the title input field 342 and from the description input field 344 is transmitted to the computer 106 (shown in FIGS. 1 and 2), and the program codes in the program memory 144 (shown in FIG. 2) cause the title field 218 and the body field 220 of an instance of the lecture table entry 212 (shown in FIG. 7) associated with the lecture represented by the lecture edit page 340 to store the text from the title input field 342 and from the description input field 344 respectively.

The lecture edit page 340 also includes an add lecture hyperlink 347 that allows the user to add the additional lectures to the course that is associated with the lecture that is associated with the lecture edit page 340.

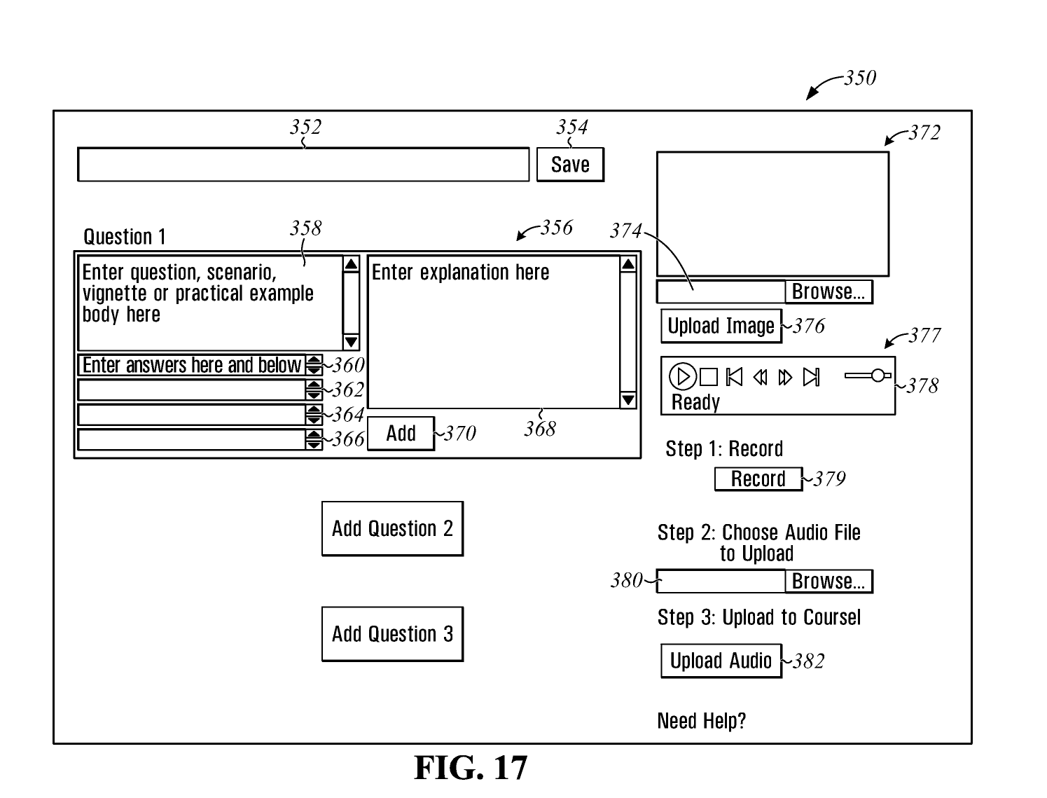

The lecture edit page 340 also includes an add coursel™ hyperlink 348 that allows the user to add an educational module in association with the lecture that is associated with the lecture edit page 340. In general in the embodiment shown, COURSEL™ is an identifier for an educational module as discussed above. Selection of the add coursel™ hyperlink 348 directs the WWW browser application of the computer 108 (shown in FIG. 1) to an add educational module page shown generally at 350 in FIG. 17 associated with a new educational module, and associated with a new instance of the educational module table entry 230 (shown in FIG. 8) associated with the new educational module.

Referring to FIG. 17, the add educational module page 350 includes a title field 352 and a title save button 354. The add educational module page 350 also includes a question information region shown generally at 356 that includes a question text field 358, answer text fields 360, 362, 364, 366, an explanation field 368, and an add question information button 370. The add educational module page 350 also includes an image information region shown generally at 372, which includes an image file name input field 374 and an upload image button 376. The add educational module page 350 also includes an audio information region 377 including an interface 378 for an audio recording application, a record button 379, an audio input file name field 380, and an upload audio button 382.

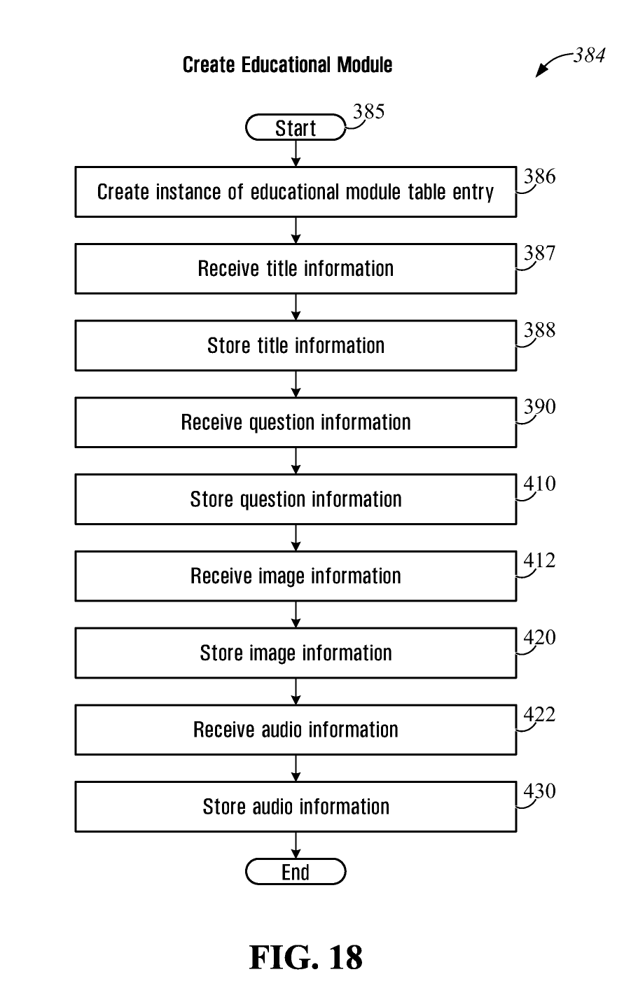

In general, the add educational module page 350 allows a teacher user of the computer 108 (shown in FIG. 1) to create an educational module associated with an instance of the educational module table entry 230 shown in FIG. 8. Therefore, referring back to FIG. 2, the program memory 144 includes create educational module program codes 384, which are also shown generally in FIG. 18. In general, the create educational module program codes 384 include blocks of code for directing the microprocessor 138 (shown in FIG. 2) to create an instance of the educational module table entry 230 (shown in FIG. 8) associated with the add educational module page 350.

Referring to FIGS. 2 and 18, the create educational module program codes 384 in the embodiment shown begin at 385 when the user interface codes 310 (shown in FIG. 2) receive an indication from the computer 108 shown in FIG. 1 that the teacher user of the computer 108 intends to create an educational module. The create educational module program codes 384 begin at block 386, which includes codes for directing the microprocessor 138 (shown in FIG. 2) to create a new instance of the educational module table entry 230 (shown in FIG. 8) and store the new instance in the educational module table 228 (shown in FIG. 3).

The create educational module program codes 384 then continue at block 387, which includes codes for directing the microprocessor 138 to receive text from the title field 352 (shown in FIG. 17) when the user selects the title save button 354 (shown in FIG. 17). The create educational module program codes 384 then continue at block 388, which includes codes for directing the microprocessor 138 to store the text from the title field 352 in the title field 234 of the new instance of the educational module table entry 230 (shown in FIG. 8).

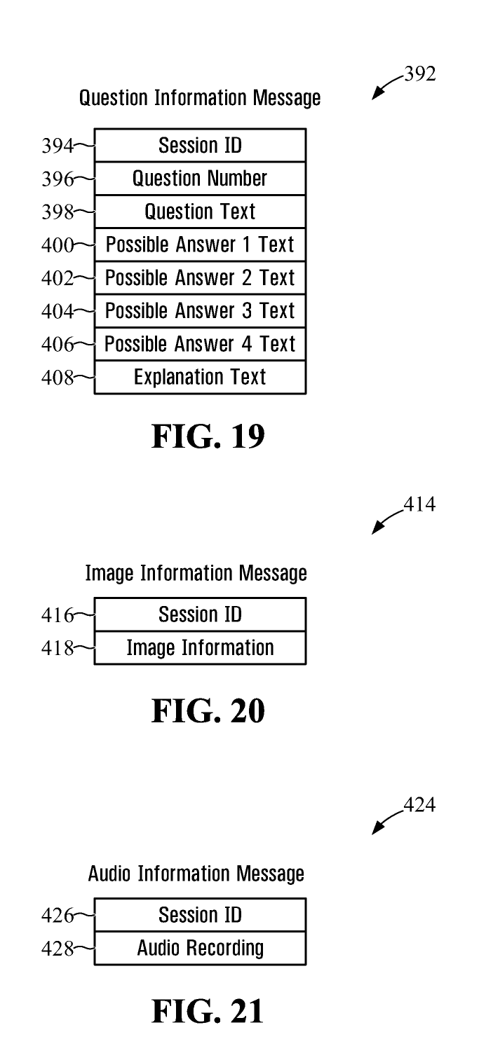

The create educational module program codes 384 then continue at block 390, which includes codes for directing the microprocessor 138 to receive question information. In the embodiment shown, the codes at block 390 direct the microprocessor 138 to receive a question information message shown generally at 392 in FIG. 19. Referring to FIG. 19, the question information message includes a session identifier field 394, a question number field 396, a question text field 398, a possible answer 1 text field 400, a possible answer 2 text field 402, a possible answer 3 text field 404, a possible answer 4 for text field 406, and an explanation text field 408.

Referring to FIGS. 17, 18, and 19, when a user of the computer 108 (shown in FIG. 1) selects the add question information button 370, the computer 108 generates a question information message 392 including a session identifier in the session identifier field 394 identifying the session created when the user of the computer 108 signed on to a session with the computer 106. Further, the question number field 396 includes a representation of question number 1 in the embodiment shown because the information entered in the question information region 356 relates to a first question for the associated educational module. However, in alternative embodiments where the user enters a second or a third question for example, the question number field will include a representation of the second question or the third question accordingly, for example. The question text field 398 of the question information message 392 includes text from the question text field 358, the possible answer text fields 400, 402, 404, and 406 include text from the answer text fields 360, 362, 364, and 366 respectively, and the explanation text field 408 includes text from the explanation field 368.

Referring back to FIGS. 2 and 18, after the question information message 392 (shown in FIG. 19) is received at block 390, the create educational module codes continue at block 410, which includes codes for directing the microprocessor 138 to store information from the question information message 392 (shown in FIG. 19). Referring to FIGS. 2, 9, 18, and 19, the codes at block 410 include codes for directing the microprocessor 138 to create a new instance of the question table entry 254 in the question table 252 (shown in FIG. 3) such that the body field 258 includes text from the question text field 398, the type field 264 indicates that the question is a multiple choice question if the possible answer text fields 400, 402, and 406 include a plurality of possible answers and that the question is a short answer question if the possible answer text fields 400, 402, 404, and 406 include only one possible answer, the user identifier field 266 includes an identifier of the user identified by the session identifier of the session identifier field 394, and the explanation field 268 includes the text from the explanation text field 408.

Further, the codes at block 410 cause the question included table 270 (shown in FIG. 3) to include a new instance of the question included table entry 272 (shown in FIG. 10), such that the new instance of the question included table entry stores an identifier of the new educational module in the educational module identifier field 276, an identifier of the new instance of the question table entry 254 (shown in FIG. 9) in the question identifier field 278, and an order in the order field 280 determined by the question number in the question number field 396.

Still further, the codes at block 410 direct the microprocessor 138 to create a new instance of the answer table entry 284 (shown in FIG. 11) for each of the possible answers identified in the possible answer text fields 400, 402, 404, and 406. Each such new instance of the answer table entry 284 includes a question identifier of the associated question in the question identifier field 288, text from one of the possible answer text fields 400, 402, 404, and 406 in the body field 290, and a user identifier of the user that created the answer associated with the instance of the answer table entry 284 in the user identifier field 296.

Referring to FIGS. 2, 17, and 18, the create educational module program codes 384 continue at block 412, which includes codes for directing the microprocessor 138 to receive image information from the computer 108 (shown in FIG. 1) in the embodiment shown. When the user selects the upload image button 376, the computer 108 transmits an image information message shown generally at 414 in FIG. 20 to the computer 106. As shown in FIG. 20, the image information message 414 includes a session identifier field 416 for identifying a session of the user at the computer 108, and an image field 418 for storing a visual image identified by the file name entered in the image file name input field 374. The codes at block 412 direct the microprocessor 138 to receive the image information message 414, and the create educational module program codes 384 continue at block 420, which includes codes for directing the microprocessor 138 to store the image information received in the image information message 414. More particularly, in the embodiment shown, the codes at block 420 direct the microprocessor 138 to store the image information received in the image field 418 in the visual image field 248 of the new instance of the educational module table entry 230 (shown in FIG. 8).

Referring back to FIGS. 2, 17, and 18, the create educational module program codes 384 continue at block 422 which includes codes for directing the microprocessor 138 to receive audio information from the computer 108 shown in FIG. 1. Referring to FIGS. 1 and 17, the computer 108 includes program codes for an audio recording application (not shown), and the audio recording application has the interface 378 shown in FIG. 17. Using the audio recording application, the user of the computer 108 may record a lecture segment to be associated with the educational module associated with the add educational module page 350 using the audio microphone 134. After recording the lecture segment, the user of the computer 108 may enter a file name for an audio file in the audio input file name field 380, and select the upload audio button 382. When the user selects the upload audio button 382 the computer 108 generates an audio information message shown generally at 424 in FIG. 21.

Referring to FIG. 21, the audio information message 424 includes a session identifier field 426 storing a session identifier indentifying the user session at the computer 108, and an audio recording field 428 including the audio recording.

Referring back to FIGS. 2 and 18, the codes at block 422 include codes for directing the microprocessor 138 to receive the audio information message 424 (shown in FIG. 21), and the create educational module program codes 384 continue at block 430, which includes codes for directing the microprocessor 138 to store the audio information received in the audio information message 424.

Referring to FIGS. 2, 3, 8, 18, and 21, the codes at block 430 include codes for directing the microprocessor 138 to store the audio information received in the audio recording field 428 in the audio recording field 250 of the new instance of the educational module table entry 230. The create educational module program codes 384 then end.

Although the create educational module program codes 384 in the embodiment shown involve receiving title information, then receiving question information, then receiving image information, and then receiving audio information, alternative embodiments may include may include receiving such information in alternative sequences and in one or more than one signal.

In some embodiments, the visual images may be retrieved from existing presentations, and for example the visual image for each educational module may be retrieved from a slide of a presentation in Microsoft™ PowerPoint™ format. In such embodiments, the create educational module program codes 384 may retrieve a Microsoft™ PowerPoint™ file, create an educational module for each slide in the Microsoft™ PowerPoint™ file, assign each such slide as the visual image for the one of the educational modules, and then allow a user to add question information and audio information substantially as described above.

In general, the question information message 392 (shown in FIG. 19), the image information message 414 (shown in FIG. 20), and the audio information message 424 (shown in FIG. 21) in the embodiment shown may be referred to as at least one signal encoded with codes representing educational information associated with an educational module, and the create educational module program codes 384 cause at least one computer-readable storage medium (the database 146 shown in FIGS. 2 and 3) to store educational information (including the information received in the question information message 392, the image information message 414, and the audio information message 424 in the embodiment shown) in association with one of a plurality of educational modules.

After a new educational module is created using the create educational module program codes 384, the educational module may be associated with a lecture by storing, in the lecture identifier field 238 of the instance of the educational module table entry 230 associated with the new educational module, a lecture identifier from the lecture identifier field 214 of an instance of the lecture table entry 212 associated with the lecture. Further, the lecture may be associated with a course by storing, in the course identifier field 226 of the instance of the lecture table entry 212 associated with the lecture, a course identifier from the course identifier field 186 of an instance of the course table entry 184 associated with the course. Still further, the user of the computer 106 (shown in FIGS. 1 and 2) in the embodiment shown may use the create educational module program codes 384 multiple times to create a plurality of educational modules associated with one or more lectures substantially as described above.

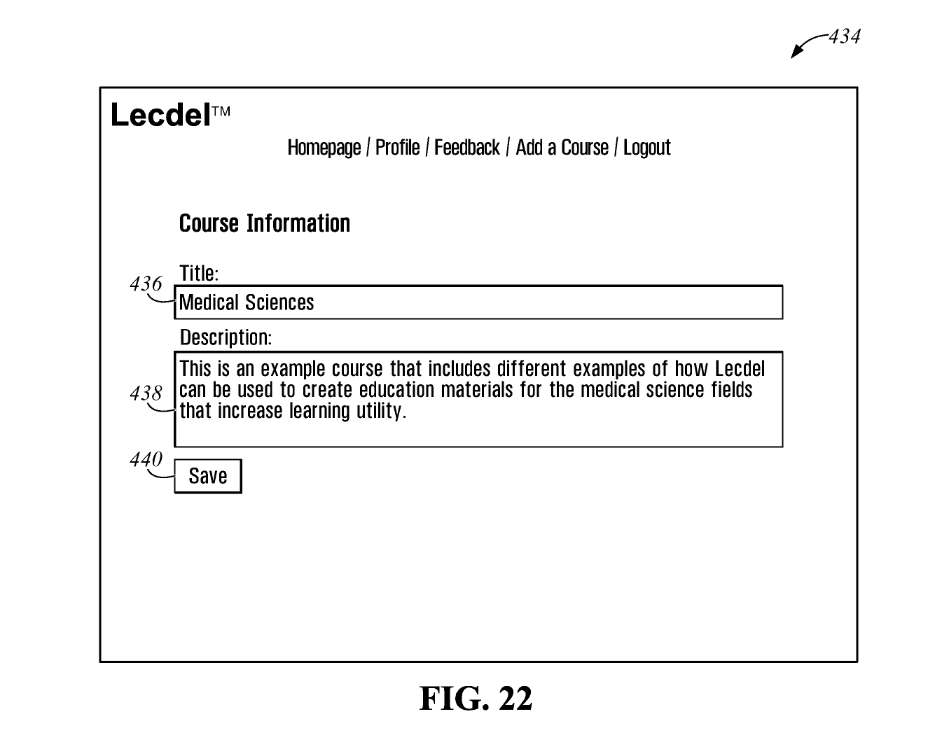

Referring back to FIG. 14, the teacher homepage 328 also includes a course add hyperlink 432 to add a course. In the embodiment shown, selection of the course add hyperlink 432 directs the WWW browser application of the computer 108 (shown in FIG. 1) to a course information page shown generally at 434 in FIG. 22.

Referring to FIG. 22, the course information page 434 includes a title text field 436 for receiving a title of a course, a description text field 438 for receiving text of a description of the course, and a save button 440. By selecting the save button 440, the user of the computer 108 (shown in FIG. 1) causes the computer 106 (shown in FIGS. 1 and 2) to create a new instance of the course table entry 184 (shown in FIG. 5) in the course table 182 (shown in FIG. 3), and the title field 190 and body field 192 of the new instance of the course table entry 184 include the text from the title text field 436 and from the description text field 438 respectively. Referring back to FIG. 14, such information about a course may be edited by a selection of a course edit hyperlink 442.

Still referring to FIG. 14, the course listing region 330 also includes, in association with the course entitled “Medical Sciences”, a delete hyperlink 444 to delete the course, and an alphanumeric course code 446, which in the embodiment shown is retrieved from the course code field 194 of an instance of the course table entry 184 (shown in FIG. 5) associated with the course. The course code may be created arbitrarily on creation of an instance of the course table entry 184, and may be distributed to students so that students can receive information associated with the course by submitting the course code. The course listing region 330 also includes similar hyperlinks and codes for the remaining courses associated with the user who established a session at the computer 108 in the embodiment shown.

Still referring to FIG. 14, the teacher homepage 328 also includes a coursel™ search field 448 for receiving text of a search query of educational modules associated with the user currently signed on. In the embodiment shown, in response to a search defined by search terms entered in the coursel™ search field 448, the computer 106 (shown in FIGS. 1 and 2) searches the educational module table 228 (shown in FIG. 3) for instances of the educational module table entry 230 (shown in FIG. 8) where the user identifier field 244 identifies the user who initiated the search, and where the text in the body field 236 matches the search terms. In other words, a user may use the search coursel™ search field 448 to search the text descriptions of educational modules associated with that user in the database 146 (shown in FIG. 2).

Referring back to FIG. 15, as the user of the computer 108 in the embodiment shown adds various educational modules to various lectures, and adds various lectures to a course, the user can develop comprehensive educational course content. In some embodiments, the lecture segments associated with educational modules may have a duration of approximately one to two minutes for example, and such educational modules may collectively form a lecture that would require approximately 60 minutes for example for a student to complete. Therefore, a student may proceed with self-contained or discrete educational modules at times that may be convenient for the student. When a particular lecture is selected in the lecture selection field 336, thumbnails of the images associated with the educational modules associated with that lecture appear in a thumbnail region shown generally at 449. Such thumbnails permit the user of the computer 108 in the embodiment shown to review the various educational modules associated with a particular lecture. In the embodiment shown, selection of one of the thumbnails in the thumbnail region 449 causes the computer 108 to display various information associated with that educational module, as shown in the example of FIG. 15.

As a user of the computer 108 in the embodiment shown develops such course material, other teachers may wish to use particular educational modules developed by the user of computer 108. Because the educational modules described herein may effectively be self-contained discrete units of education, transferring such educational modules may conveniently facilitate the distribution of educational information between collaborating teachers. Therefore, referring back to FIG. 2, the user interface codes 310 include codes for displaying a transfer page on the display screen 128 (shown in FIG. 1).

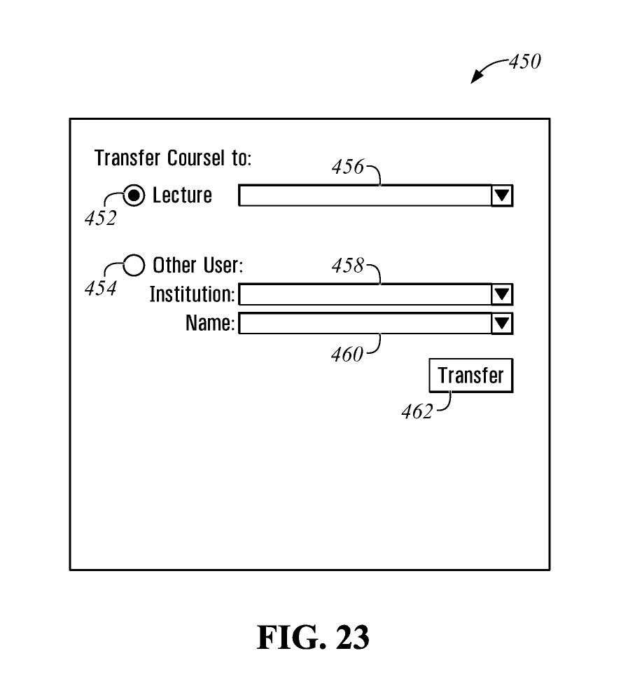

Referring to FIG. 23, the transfer page is shown generally at 450 and in the embodiment shown includes an HTML radio button 452 to allow the user to transfer an educational module to a different lecture of the same user, and an HTML radio button 454 to allow the user to transfer the educational module to a different user. The transfer page 450 also includes a lecture selection field 456, which in the embodiment shown is an HTML drop-down list to allow the user to select a user's own lecture to receive the educational module. The transfer page 450 also includes an institution selection field 458, which in the embodiment shown is an HTML drop-down list including institutions (such as universities, colleges, and other post-secondary institutions, for example) with which the user may collaborate. The transfer page 450 also includes a name selection field 460 listing names of other users at an institution selected by the institution selection field 458 with which the current user may collaborate. The transfer page 450 also includes a transfer button 462, and selection of the transfer button 462 causes the microprocessor 138 to execute transfer educational module program codes 464 in the program memory 144 (shown in FIG. 2).

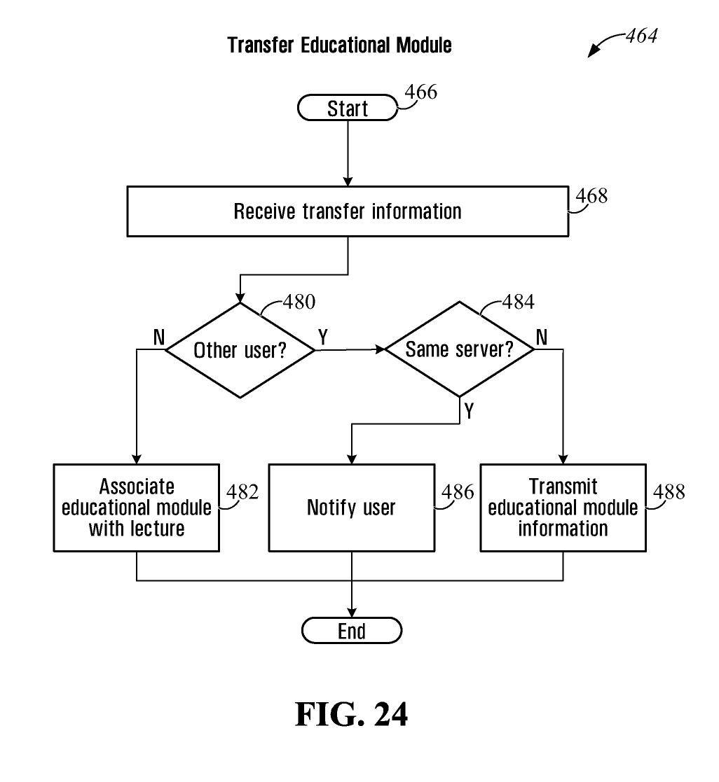

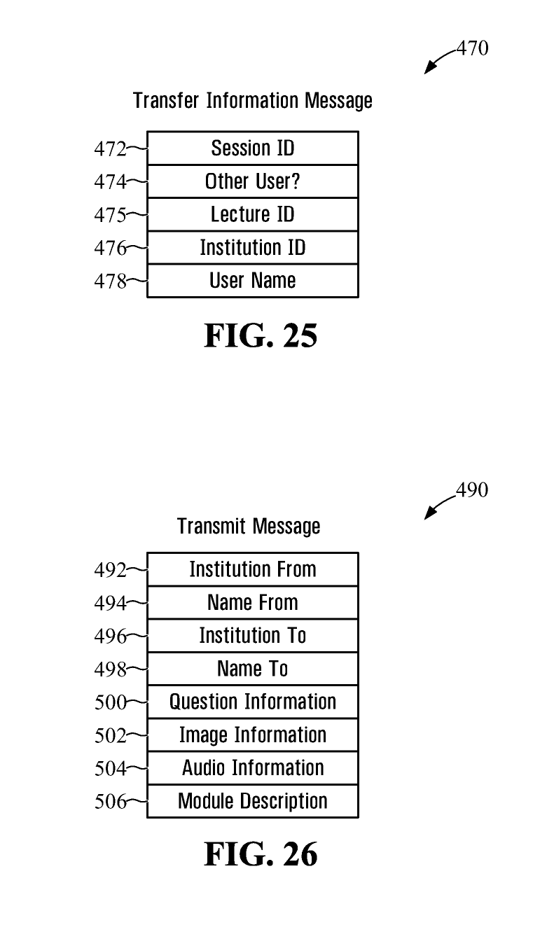

Referring to FIGS. 2 and 24, the transfer educational module program codes 464 begin at 466 in response to selection of the transfer button 462, and continue at block 468, which includes codes for directing the microprocessor 138 to receive transfer information from the user of computer 108 in the embodiment shown. In the embodiment shown, selection of the transfer button 462 (shown in FIG. 23) by the user of the computer 108 (shown in FIG. 1) causes the computer 108 to generate a transfer information message shown generally at 470 in FIG. 25.

Referring to FIGS. 23 and 25, the transfer information message 470 includes a session identifier field 472, a Boolean other user field 474, a lecture identifier field 475, an institution identifier field 476, and a user name field 478. The session identifier in the session identifier field 472 identifies a session of a user of the computer 108, and therefore also identifies that user and the educational module associated with the transfer page 450. The Boolean other user field 474 indicates whether the radio button 452 was selected to indicate that the educational module is transferred to the same user, or whether the radio button 454 was selected to indicate that the educational module is to be transferred to another user. The lecture identifier field 475 identifies the lecture selected in the lecture selection field 456. The institution identifier field identifies an institution selected from the institution selection field 458, and the user name field 478 identifies a user name selected from the user name selection field 460.

Referring to FIGS. 2, 24, and 25, the transfer educational module program codes 464 continue at block 480, which includes codes for directing the microprocessor 138 to determine whether the Boolean other user field 474 indicates that the educational module is to be transferred to another user. If at block 480 the educational module is to be transferred to the same user, then the transfer educational module program codes 464 continue at block 482, which includes codes for directing the microprocessor 138 to associate the educational module identified by the session identifier field 472 with the lecture identified by the lecture identifier field 475.

In the embodiment shown, the codes at block 482 direct the microprocessor 138 to create a new instance of the educational module table entry 230, and the new instance of the educational module table entry 230 includes a title in the title field 234, a body in the body field 236, a user identifier in the user identifier field 244, a visual image in the visual image field 248, and an audio recording in the audio recording field 250 that are copied from those fields of the educational module that is being transferred. Further, the lecture identifier of the new instance of the educational module table entry identifies the lecture identified by the lecture identifier field 475. Still further, the codes at block 482 cause new instances of the question table entry 254 (shown in FIG. 9), of the question included table entry 272 (shown in FIG. 10), and of the answer table entry 284 (shown in FIG. 11) so that the transferred educational module includes the same question and answers as the transferred educational module. The codes at block 482 thus cause the database 146 to associate an educational module with a second lecture different from a first lecture with which the educational module was previously associated. After block 482, the transfer educational module program codes 464 end.

However, if at block 480 the educational module is to be transferred to another user, then the transfer educational module program codes 464 continue at block 484, which includes codes for directing the microprocessor 138 to determine whether the institution identified in the institution identifier field 476 is associated with the computer 106 or with another computer such as the computer 104 (shown in FIG. 1). In general, a computer such as the computer 106 may be associated with a single institution, or with more than one institution. In some embodiments, a user may transfer educational modules to users with other institutions that are not associated with the computer 106 but may instead be associated with the computer 104, which in the embodiment shown is substantially the same as the computer 106.

If at block 484 the institution identified in the institution identifier field 476 uses the same server, namely the computer 106 in the embodiment shown, then the transfer educational module program codes 464 continue at block 486, which includes codes for directing the microprocessor 138 to notify the user identified by the user name field 478 of the transfer of the educational module. Once so notified, the user may then associate the educational module with the desired lecture substantially as described above, and thus the codes at block 486 may also cause the database 146 to associate an educational module with a second lecture (the lecture of the user to which the educational module was transferred) different from a first lecture with which the educational module was previously associated.

However, if at block 484 the institution identified by the institution identifier field is not associated with the computer 106, then the transfer educational module program codes 464 continue at block 488, which includes codes for directing the microprocessor 138 to transmit information regarding the educational module to a server associated with the institution identified by the institution identifier field 476, which in the embodiment shown is the computer 104 (shown in FIG. 1). In the embodiment shown, the codes at block 488 direct the microprocessor 138 to retrieve educational information (which, in the embodiment shown, includes at least one question, instructional information including a visual image and an audio recording, and at least one explanation for a respective correct answer to a respective one of the at least one question) associated with the educational module from the database 146 (shown in FIG. 1), and to transmit the retrieved educational information in a transmit message shown generally at 490 in FIG. 26.

Referring to FIG. 26, the transmit message 490 includes an institution from field 492 storing a representation of the institution from which the educational module is being transmitted, a name from field 494 representing the user who is transmitting the educational module, an institution to identifier 496 identifying the institution identified in the institution identifier field 476 (shown in FIG. 25), a name to field 498 identifying the user identified in the user name field 478 (shown in FIG. 25), a question information field 500 including question information associated with the educational module, an image information field 502 including image information associated with the educational module, an audio information field 504 including audio information associated with the educational module, and a module description field 506 including a module description retrieved from the body field 236 of an instance of the educational module table entry 230 (shown in FIG. 8) associated with the educational module to be transmitted.

In general, the transmit message 490 is encoded with information sufficient to transmit the entire educational module to the institution identified in the institution field 496 and the user at that institution identified by the name to field 498. The transmit message 490 therefore may be referred to as at least one signal transmitting educational information associated with an educational module. When the computer 104 receives the transmit message 490, the computer 104 may notify the user identified by name to field 498, and that user may then associate the educational module with one or more lectures substantially as described above, and thus the codes at block 488 may cause at least one computer-readable storage medium (the database of the computer 104 in the embodiment shown) to associate an educational module with a second lecture (the lecture of the user of the computer 104) different from a first lecture with which the educational module was previously associated.

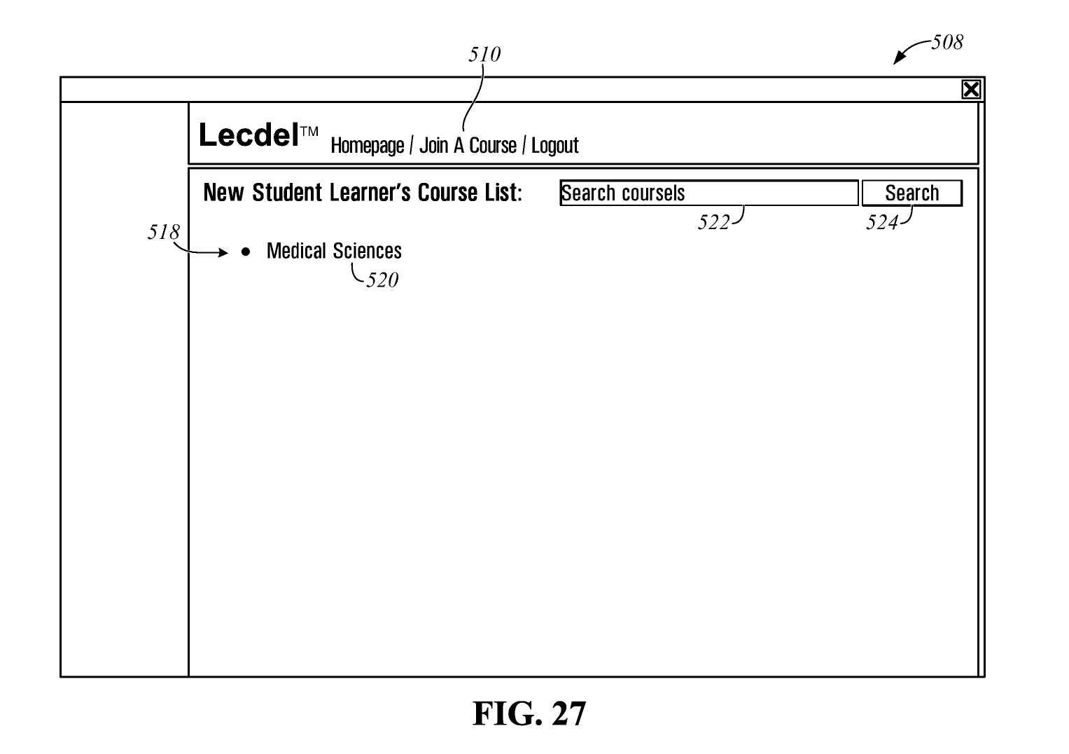

Referring back to FIGS. 1, 2, and 13, if the user who completes the user sign-in region 329 is a student using the computer 102, then the user interface codes 310 cause the WWW browser application of the computer 102 to display a student homepage shown generally at 508 in FIG. 27 on the display screen 112.

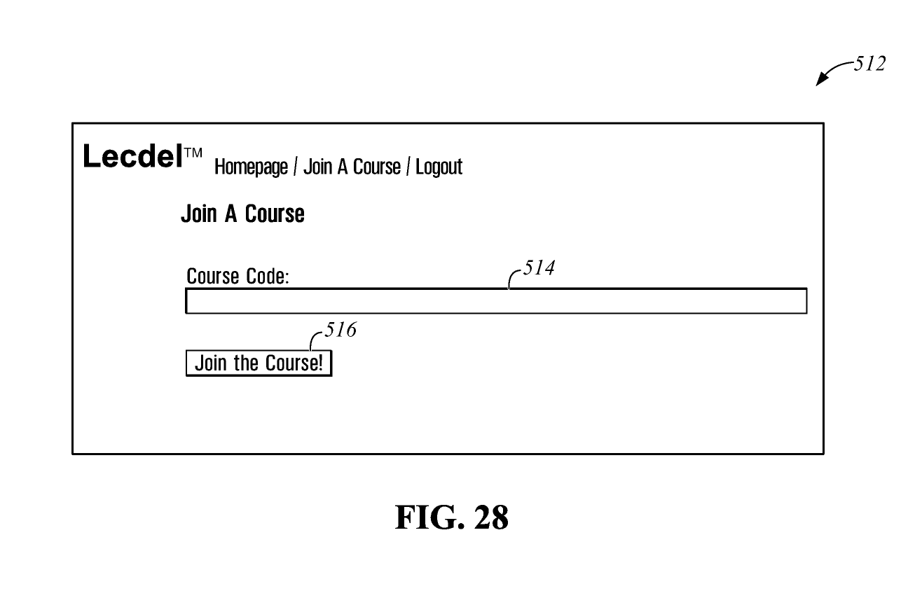

Referring to FIG. 27, the student homepage 508 includes a join course hyperlink 510. When the user of the computer 102 selects the join course hyperlink 510, the WWW browser application of the computer 102 is directed to a join course page shown generally at 512 in FIG. 28.

Referring to FIG. 28, the join course page 512 includes a course code field 514 and a join course button 516. The user of the computer 102 may enter a course code, such as the course code 446 (shown in FIG. 14) for example, and select the join course button 516 to join the course identified by that course code.

Referring back to FIG. 27, the student homepage 508 also includes a course list shown generally at 518, which in the embodiment shown includes a hyperlink 520 to the course entitled “Medical Sciences”, which in the embodiment shown is the course identified by the course code 446 (shown in FIG. 14). The student homepage 508 also includes a coursel™ search field 522 and a coursel™ search button 524. When the user of the computer 102 in the embodiment shown enters text in the coursel™ search field 522 and selects the coursel™ search button 524, the computer 102 transmits a signal to the computer 106 to search the body fields 236 of instances of the educational module table entry 230 (shown in FIG. 8) associated with educational modules that are associated with lectures that are associated with courses that the user of the computer 102 is registered in according to the registration table 200 (shown in FIG. 3).

Still referring to FIG. 27, if the user of the computer 102 selects the hyperlink 520, then the computer 102 transmits a signal to the computer 106 directing the computer 106 to execute distribute educational course content program codes 526 in the program memory 144 (shown in FIG. 2).

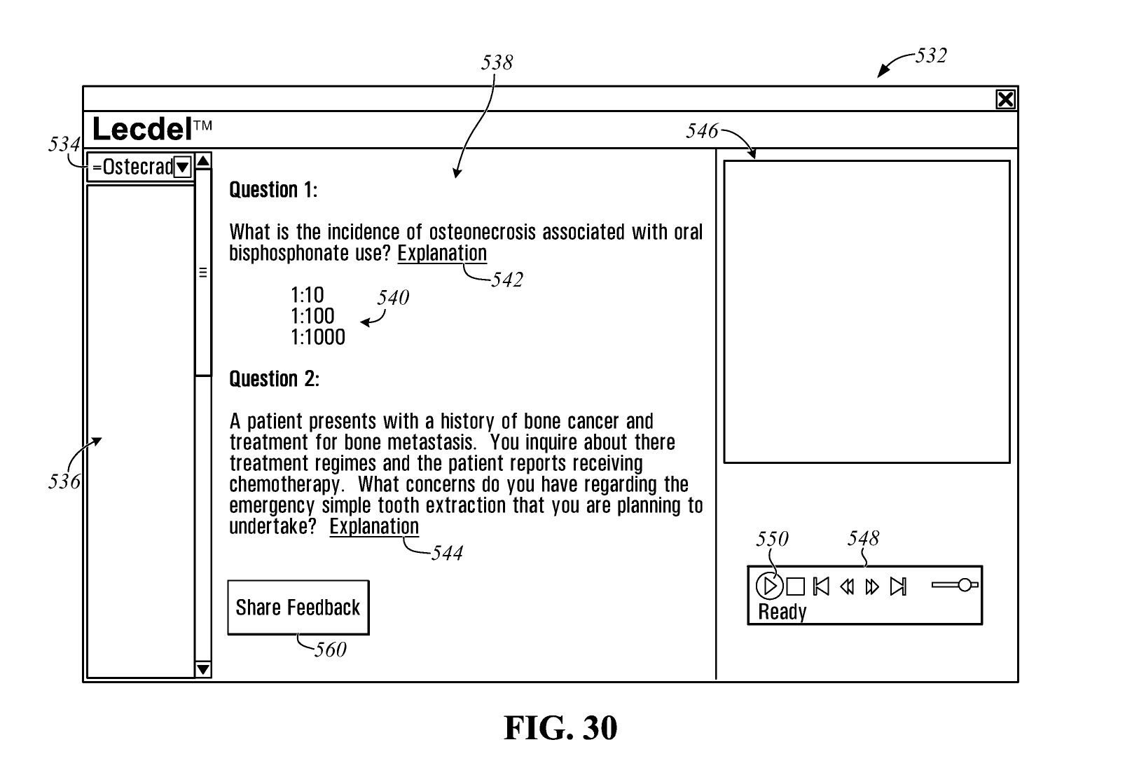

Referring to FIGS. 1, 2, and 29, the distribute educational course content program codes 526 begin at block 528, which includes codes for directing the microprocessor 138 to receive a request from the user of the computer 102 for educational content associated with an educational module. The distribute educational course content program codes 526 continue at block 530, which includes codes directing the microprocessor 138 to retrieve visual information associated with the educational module from the database 146, and to cause the computer 102 to display the visual information associated with the educational module. In the embodiment shown, the codes at block 530 include codes for directing the microprocessor 138 to transmit a signal encoded with HTML codes to cause an educational module student display page shown generally at 532 in FIG. 30 to appear in the WWW browser application of the computer 102 on the display screen 112.

Referring to FIGS. 1, 29, and 30, the educational module student display page 532 includes a lecture selection field 534, which in the embodiment shown is an HTML drop down list including items for each of the lectures in the course that the user selected. When the user selects one of the lectures from the lecture selection field 534, an educational module thumbnail region shown generally at 536 displays thumbnail images for each of the educational modules associated with the selected lecture. Therefore, the user of the computer 102 may review the thumbnail images in the educational module thumbnail region 536, and select one of the educational modules for presentation on the display screen 112 of the computer 102.

In response to selection of one of the educational modules, the codes at block 530 in the embodiment shown direct the microprocessor 138 to retrieve questions associated with the educational module from the database 146, and to transmit HTML codes that cause the display screen 112 to display the questions in a question region shown generally at 538 of the educational module student display page 532. Where one of the questions includes multiple-choice answers, the codes at block 530 also direct the microprocessor 138 to retrieve the possible answers associated with the question from the database 146, and the HTML codes also cause the display screen 112 to display text of the possible answers, as shown generally at 540 for example. The questions are also displayed adjacent explanation hyperlinks 542 and 544. The codes at block 530 also direct the microprocessor 138 to retrieve image associated with the educational module from the database 146, and the HTML codes generated by the program codes at block 530 also cause the image associated with the educational module to be displayed in an image region shown generally at 546. Further, the HTML codes in the embodiment shown cause the display screen 112 to display an audio player interface 548 to an audio player application on the computer 102 to play an audio recording on the audio speakers 114 and 116. Such HTML codes may thus be referred to as codes encoded in at least one signal that causes the computer 102 to present instructional information associated with one of a plurality of educational modules.

In the embodiment shown, the question region 538 is on a left side of the display screen 112, whereas the image region 546 and the audio player interface 548 are on a right side of the display screen 112. Although alternative embodiments may include different arrangements, such as an image region and audio player interface on a left side and a question region on a right side for example, the arrangement of the embodiment shown in FIG. 30 may direct the user's attention first to the questions, and then subsequently to the image in the image region 546 and to the audio player interface 548 in the embodiment shown, and thus such an arrangement may advantageously focus a student's attention first on the questions before directing attention to the instructional information on the right side of the display screen 112 to facilitate some possible advantages of problem-based learning.

Referring to FIGS. 2, 29, and 30, the student may select a play button 550 on the audio player interface 548, which causes a signal to be transmitted to the computer 106 to request presentation of the audio recording associated with the educational module. Therefore, the distribute educational course content program codes 526 continue at block 552, which includes codes for directing the microprocessor 138 to receive the request. The distribute educational course content program codes 526 then continue at block 554, which includes codes for directing the microprocessor 138 to retrieve the audio recording associated with the educational module from the database 146, and to cause the computer 102 to present the audio recording associated with the educational module. In the embodiment shown, the codes at block 554 cause the microprocessor 138 to transmit a signal to the computer 102 to direct the audio player application on the computer 102 to present the audio recording on the audio speakers 114 and 116 (shown in FIG. 1). In some embodiments, the user of the computer 102 may be able to vary a playback speed of the audio recording on the audio player application, so that a student could hear the lecture segment slower or faster than a speed at which the lecture segment was recorded, for example.

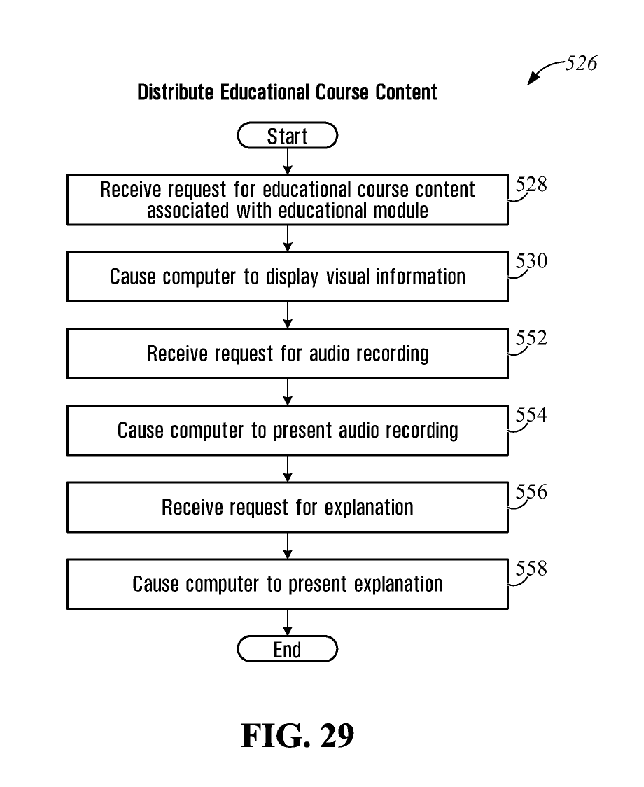

Referring back to FIG. 30, the user of the computer 102 (shown in FIG. 1) may select one of the explanation hyperlinks 542 or 544, either of which causes the computer 102 to transmit a signal to the computer 106 (shown in FIGS. 1 and 2) to request the associated explanation. Therefore, referring back to FIGS. 2 and 29, the distribute educational course content program codes 526 continue at block 556, which includes codes for directing the microprocessor 138 to receive the request for the explanation. The distribute educational course content codes then continue at block 558, which includes codes for directing the microprocessor 138 to retrieve text of the explanation from the database 146, and to cause the computer 102 to present text of the explanation. In the embodiment shown, the codes at block 558 direct the microprocessor 138 to transmit a signal to the computer 102 to cause the WWW browser application of the computer 102 to display the text of the explanation, for example in a pop-up window (not shown) on educational module student display page shown generally at 532 adjacent the selected explanation hyperlink 542 or 544. The distribute educational course content codes then end.

In alternative embodiments, the distribution of the educational course content may be in different sequences. For example, the user may request an explanation before requesting the audio recording, or the user may choose not to request the explanation if, for example, the user is already confident of the user's knowledge of the answer to the question.

In summary, the computer 106 (shown in FIGS. 1 and 2) causes the computer the computer 102 (shown in FIG. 1) to present educational information retrieved from a first at least one computer-readable storage medium (the database 146 shown in FIGS. 2 and 3). In the embodiment shown, such educational information is stored in the database 146 in association with an instance of the educational module entry 230 (shown in FIG. 8), and is therefore stored in the database 146 in association with one of a plurality of educational modules.

Further, in the embodiment shown, such educational information presented includes at least one question (shown at 538 in FIG. 30), instructional information (the visual image in the image region 546 shown in FIG. 30, and the audio recording associated with the educational module), and at least one explanation for a respective correct answer to a respective one of the at least one question (in response to user selection of the explanation hyperlink 542 or 544 shown in FIG. 30), and such instructional information is presented independently of any selection by the user of the computer 102 of the possible answers, as the possible answers shown generally at 540. Presenting the instructional information independently of any such user selection of the possible answers may facilitate some of the possible advantages of problem-based learning.

Still further, in the embodiment shown, the at least one question is included in the educational module student display page 532 shown in FIG. 30 along with the possible answers shown generally at 540, the visual image in the image region 538, and the audio player interface 548 that allows the user to request presentation of the audio recording associated with the educational module. Therefore, in the embodiment shown, the computer 106 causes the computer 102 to present the visual image, the possible answers, and the at least one question contemporaneously, and to present at least a portion of the instructional information while the at least one question is being presented by the computer 102.

In general, therefore, the computer 106 is an illustrative apparatus for distributing educational course content to a user of the computer 102.

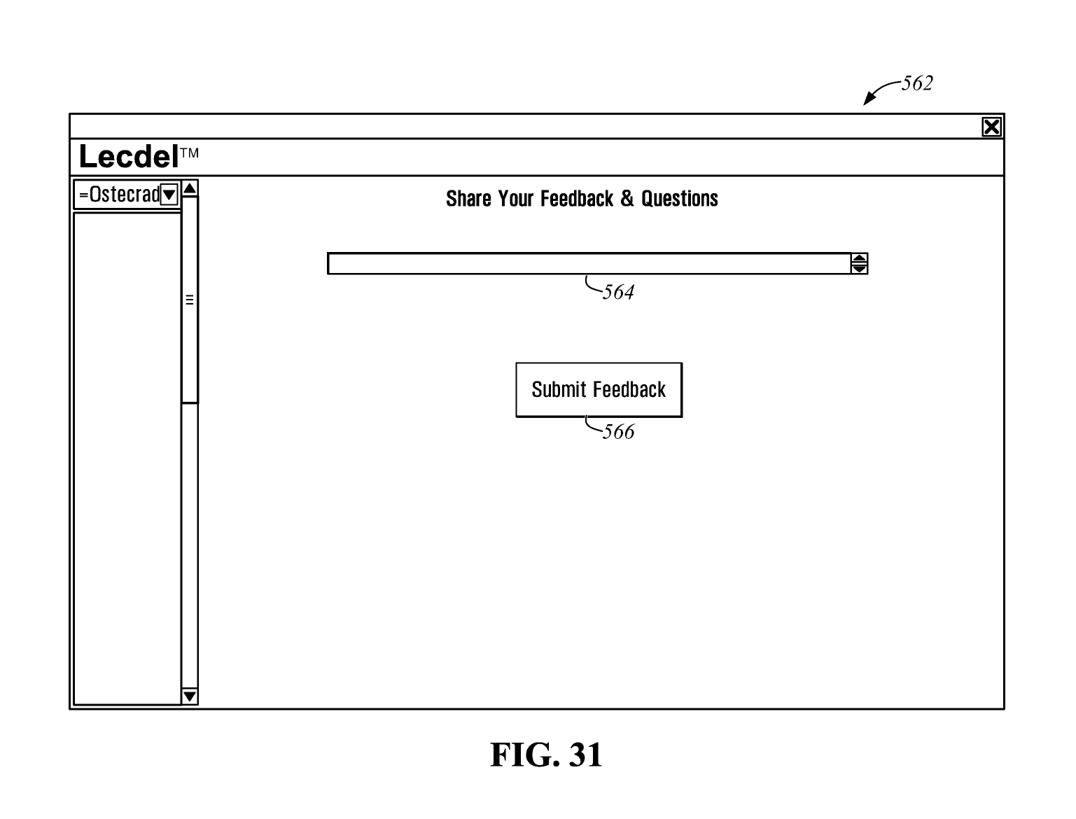

Referring back to FIG. 30, the educational module student display page 532 also includes a share feedback button 560. If the user of the computer 102 (shown in FIG. 1) selects the share feedback button 560, then the browser application of the user is directed to a share feedback page shown generally at 562 in FIG. 31 and associated with the educational module that was shown on the educational module student display page 532 when the user selected the share feedback button 560.

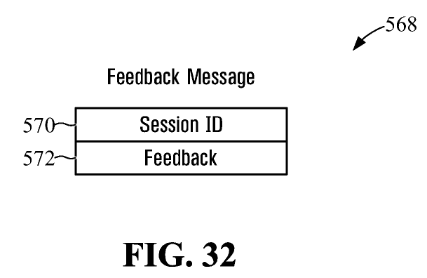

Referring to FIG. 31, the share feedback page 562 includes a feedback field 564 and a submit feedback button 566. When the user selects the submit feedback button 566, text from the feedback field 564 is transmitted to the computer 106 (shown in FIGS. 1 and 2) in at least one signal, which in the embodiment shown is encoded with a feedback message shown generally at 568 in FIG. 32.

Referring to FIG. 32, the feedback message 568 includes a session identifier field 570 that identifies a session of a user of the computer 102 (shown in FIG. 1), and therefore also identifies that user and the educational module associated with the share feedback page 562. The feedback message 568 also includes a feedback text field 572 for storing the text from the feedback field 564 (shown in FIG. 31). Therefore, the feedback is transmitted from the computer 102 to the computer 106 (shown in FIGS. 1 and 2) in association with the educational module that was represented on the educational module student display page 532 when the user selected the share feedback button 560 (shown in FIG. 30). When the computer 106 receives such feedback, the microprocessor 138 executes receive feedback program codes 574 in the program memory 144 (shown in FIG. 2).

Referring to FIGS. 2, 12, and 32, the receive feedback program codes 574 direct the microprocessor 138 to create a new instance of the feedback table entry 300, such that the user identifier field 304 of the new instance identifies the user of the computer 102 (shown in FIG. 1) that submitted the feedback as identified by the session identifier field 570, the educational module identifier field 306 identifies the educational module in association with which the user submitted the feedback as identified by the session identifier field 570, and the body field 308 of the new instance includes the text from the feedback text field 572.

Referring back to FIG. 14, the teacher homepage 328 includes a feedback region shown generally at 576 to inform a teacher of the course associated with the lecture associated with the educational module in association with which the feedback was received of such feedback.

Still referring to FIG. 14, the teacher homepage 328 includes a LECDEX™ region shown generally at 578 to inform a teacher who is signed in to the teacher homepage 328 of a number (shown generally at 580) of educational modules (identified as coursels™ in the embodiment shown) that are actively available to be exchanged or transferred, such as by the transfer educational module program codes 464 described above and illustrated in FIG. 24. The LECDEX™ region 578 also includes an indication shown generally at 582 of a number of credits available to the teacher who is signed in to the teacher homepage 328. In some embodiments, various users, such as users of the computers 104 and 106 (shown in FIG. 1) in the embodiment shown, may accumulate credits, for example by transferring educational modules to other users, and may consume such credits, for example by receiving educational modules from other users. Such credits may be non-monetary in some embodiments, or may be monetary in other embodiments. In other embodiments, educational modules may be freely exchanged without any credits, for example.

Still referring to FIG. 14, the teacher homepage 328 includes a collaboration region shown generally at 584 to inform the teacher who is signed in to the teacher homepage 328 of various updates that may facilitate collaboration with various other users, such as users of the computers 104 and 106 (shown in FIG. 1) in the embodiment shown. For example, in the embodiment shown, the collaboration region 584 includes a message shown generally at 586 indicating that another user, identified as Dr. Matthew, updated a lecture entitled “Oral Surgery”.

In general, the illustrative embodiments described above may facilitate collaborative education, which may involve problem-based learning in many embodiments. For example, some of the illustrative embodiments described above may permit a single teacher to make online learning available to students using problem-based learning, and therefore may achieve greater retention than may be achieved when compared to online learning that more closely resembles traditional didactic learning methods. Such embodiments may permit feedback to be received in association with a specific educational module, rather than more generally in association with a broader lecture or with an even broader course. Feedback directed specifically at such an educational module or discrete unit of education may facilitate more effective revision of educational course content by directing a teacher's attention to the specific educational module or discrete unit of education associated with the feedback. Further, a teacher can revise only a small educational module, rather than having to revise an entire lecture, for example. Still further, the illustrative embodiments described above may facilitate development of comprehensive educational course content across various courses maintained by a single teacher, because that teacher may search educational modules to identify educational modules that may be applicable in a variety of courses, and incorporate the same educational module in various courses for example. In some embodiments, the online delivery of educational course content as described above may complement live lectures or other classroom time, and in other embodiments the online delivery of educational course content as described above may replace live lectures or other classroom time.

Still further, some of the illustrative embodiments described above may permit multiple teachers at one or more institutions to exchange educational modules as discrete educational units, which may facilitate efficient collaboration between various teachers and in some embodiments across various institutions. For example, teachers at the same or different institutions may be able to search educational modules of numerous other teachers, for example, and incorporate such educational modules in one or more lectures. In the illustrative embodiments described above, such collaboration may involve the educational modules themselves, rather than entire lectures or entire courses, which may permit collaboration more efficiently than when compared to other methods of exchanging educational course content.

Although specific embodiments have been described and illustrated, such embodiments should be considered illustrative only and not as limiting the invention as construed in accordance with the accompanying claims.

1. A method of distributing educational course content to a user of a first computer, the method comprising:
causing the first computer to present educational information retrieved from a first at least one computer-readable storage medium comprising the educational information stored thereon in association with one of a first plurality of educational modules, the educational information presented by the first computer and stored on the first at least one computer-readable storage medium in association with the one of the first plurality of educational modules comprising at least one question, instructional information, and at least one explanation for a respective correct answer to a respective one of the at least one question;
wherein causing the first computer to present the educational information comprises causing the first computer to present at least a portion of the instructional information while the at least one question is being presented by the first computer.

2-56. (canceled)

57. An apparatus for distributing educational course content to a user of a first computer, the apparatus comprising:
a communication interface configured to communicate with the first computer;
a storage medium interface configured to communicate with a first at least one computer-readable storage medium; and
a processor circuit in communication with the communication interface and the storage medium interface, and configured to:
retrieve educational information from the first at least one computer-readable storage medium comprising the educational information stored thereon in association with one of a first plurality of educational modules, wherein the educational information that the processor circuit is configured to retrieve from the first at least one computer-readable storage medium comprises at least one question, instructional information, and at least one explanation for a respective correct answer to a respective one of the at least one question; and
cause the first computer to present the educational information retrieved from the first at least one computer-readable storage medium, wherein the processor circuit is configured to cause the first computer to present at least a portion of the instructional information while the at least one question is being presented by the first computer.

58. The apparatus of claim 57 wherein the processor circuit is configured to cause the first computer to display text of the at least one question.

59. The apparatus of claim 58 wherein the processor circuit is configured to cause the first computer to display the text of the at least one question on a display screen of the first computer.

60. The apparatus of claim 59 wherein the instructional information that the processor circuit is configured to retrieve from the first at least one computer-readable storage medium, and that the processor circuit is configured to cause the first computer to present, comprises at least one visual image.

61. The apparatus of claim 60 wherein the processor circuit is configured to cause the first computer to display the at least one visual image on the display screen of the first computer.

62. The apparatus of claim 61 wherein the processor circuit is configured to cause the first computer to display the at least one visual image on the display screen of the first computer contemporaneously with the text of the at least one question.

63. The apparatus of claim 61 wherein the processor circuit is configured to cause the first computer to present the at least one question on a left side of the display screen of the first computer and to present the at least one visual image on a right side of the display screen of the first computer.

64. The apparatus of claim 61 wherein the processor circuit is configured to cause the first computer to present the at least one question on a right side of the display screen of the first computer and to present the at least one visual image on a left side of the display screen of the first computer.

65. The apparatus of claim 57 wherein the instructional information that the processor circuit is configured to retrieve from the first at least one computer-readable storage medium, and that the processor circuit is configured to cause the first computer to present, comprises at least one audio recording of at least one lecture segment.

66. The apparatus of claim 65 wherein the processor circuit is configured to cause the first computer to present the at least one audio recording in response to a request from the user of the first computer for presentation of the at least one audio recording.

67. The apparatus of claim 57 wherein the educational information that the processor circuit is configured to retrieve from the first at least one computer-readable storage medium, and that the processor circuit is configured to cause the first computer to present, further comprises a plurality of possible answers to each one of the at least one question.

68. The apparatus of claim 67 wherein the processor circuit is configured to cause the first computer to display text of the possible answers.

69. The apparatus of claim 67 wherein the processor circuit is configured to cause the first computer to present the at least one question and the possible answers contemporaneously.

70. The apparatus of claim 67 wherein the processor circuit is configured to cause the first computer to present the instructional information independently of any selection of any of the possible answers by the user of the first computer.

71. The apparatus of claim 57 wherein the processor circuit is configured to cause the first computer to present the at least one explanation in response to a request from the user of the first computer for the at least one explanation.

72. The apparatus of claim 57 wherein the processor circuit is configured to cause the first computer to display text of the at least one explanation.

73. The apparatus of claim 57 wherein the processor circuit is further configured to cause the communication interface to transmit, to the first computer, a first at least one signal encoded with codes to cause the first computer to present the educational information.

74. The apparatus of claim 73 wherein the codes of the first at least one signal comprise hypertext markup language codes.

75. The apparatus of claim 57 wherein the processor circuit is further configured to cause the first at least one computer-readable storage medium to store the educational information in association with the one of the first plurality of educational modules.

76. The apparatus of claim 75 wherein the processor circuit is further configured to receive the educational information.

77. The apparatus of claim 76 wherein the processor circuit is configured to receive a second at least one signal encoded with codes representing the educational information associated with the one of the first plurality of educational modules.

78. The apparatus of claim 57 wherein the processor circuit is further configured to cause the first at least one computer-readable storage medium to associate the one of the first plurality of educational modules with a first one of a plurality of lectures.

79. The apparatus of claim 78 wherein the processor circuit is further configured to cause the first at least one computer-readable storage medium to associate the first one of the plurality of lectures with a first one of a plurality of courses.

80. The apparatus of claim 78 wherein the processor circuit is further configured to cause the first at least one computer-readable storage medium to associate the one of the first plurality of educational modules with a second one of the plurality of lectures different from the first one of the plurality of lectures.

81. The apparatus of claim 78 wherein the processor circuit is further configured to cause the first at least one computer-readable storage medium to associate a plurality of educational modules of the first plurality of educational modules with the first one of the plurality of lectures, and wherein the processor circuit is further configured to cause the first at least one computer-readable storage medium to store thereon, in association with each one of the first plurality of educational modules associated with the first one of the plurality of lectures, a respective at least one question, respective instructional information, and a respective at least one explanation for a respective correct answer to a respective one of the respective at least one question.

82. The apparatus of claim 57 wherein the processor circuit is further configured to cause a second at least one computer-readable storage medium different from the first at least one computer-readable storage medium to store the educational information in association with one of a second plurality of educational modules different from the first plurality of educational modules.

83. The apparatus of claim 82 wherein the processor circuit is further configured to cause the communication interface to transmit a third at least one signal to a second computer comprising the second at least one computer-readable storage medium.

84. The apparatus of claim 57 wherein the processor circuit is further configured to:
receive, from the first computer, a fourth at least one signal encoded with codes representing feedback associated with the one of the first plurality of educational modules; and
cause the first at least one computer-readable storage medium to store the feedback in association with the one of the first plurality of educational modules.

85-100. (canceled)

101. An apparatus for facilitating distribution of educational course content, the apparatus comprising:
a communication interface configured to communicate with a computer;
a storage medium interface configured to communicate with at least one computer-readable storage medium; and
a processor circuit in communication with the communication interface and the storage medium interface, and configured to:
receive, over the communication interface, at least one signal encoded with codes representing educational information comprising at least one question, instructional information, and at least one explanation for a respective correct answer to a respective one of the at least one question;
cause the at least one computer-readable storage medium to store thereon the educational information in association with one of a first plurality of educational modules; and
cause the at least one computer-readable storage medium to associate the one of the first plurality of educational modules with a first one of a plurality of lectures.

102. The apparatus of claim 101 wherein the instructional information comprises at least one audio recording of at least one lecture segment.

103. The apparatus of claim 101 wherein the instructional information comprises at least one visual image.

104. The apparatus of claim 101 wherein the educational information further comprises a plurality of possible answers to each one of the at least one question.

105. The apparatus of claim 101 wherein the processor circuit is further configured to cause the at least one computer-readable storage medium to associate the first one of the plurality of lectures with a first one of a plurality of courses.

106. The apparatus of claim 105 wherein the processor circuit is further configured to cause the at least one computer-readable storage medium to associate the first one of the plurality of lectures with a second one of the plurality of courses different from the first one of the plurality of courses.

107. The apparatus of claim 101 wherein the processor circuit is further configured to cause the at least one computer-readable storage medium to associate the one of the first plurality of educational modules with a second one of the plurality of lectures different from the first one of the plurality of lectures.

108. The apparatus of claim 101 wherein the processor circuit is further configured to cause the at least one computer-readable storage medium to associate a plurality of educational modules of the first plurality of educational modules with the first one of the plurality of lectures, and wherein the processor circuit is further configured to cause the at least one computer-readable storage medium to store thereon, in association with each one of the first plurality of educational modules that is associated with the first one of the plurality of lectures, a respective at least one question, respective instructional information, and a respective at least one explanation for a respective correct answer to a respective one of the respective at least one question.
